(19) United States
(12) Patent Application Publication
(10) Pub. No.: US 2025/0097362 A1
(43) Pub. Date: Mar. 20, 2025

(54) INFORMATION PROCESSING APPARATUS THAT ENABLES IMAGE PROCESSING APPARATUSES OF A PLURALITY OF MAKERS TO READ IMAGE, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: SHOICHI KANNO, Kanagawa (JP)

(21) Appl. No.: 18/828,946

(22) Filed: Sep. 9, 2024

(30) Foreign Application Priority Data
Sep. 14, 2023 (JP) 2023-149235

(51) Int. Cl. H04N 1/00; H04N 1/32

(52) U.S. Cl. CPC H04N 1/0097; H04N 1/00204; H04N 1/32101; H04N 2201/0081; H04N 2201/0094; H04N 2201/3204

(57) ABSTRACT

An information processing apparatus communicably connected to an image forming apparatus having a reading unit for reading an image and processing information transmitted and received to and from the image forming apparatus. The image forming apparatus stores, in advance, first information concerning first capabilities which are commonly set by makers of the image forming apparatus and can be standardly executed by the reading unit, and second information concerning second capabilities which are uniquely set by a predetermined maker of the image forming apparatus and can be executed by the reading unit. The information processing apparatus acquires the first information and the second information from the image forming apparatus by using a common protocol commonly set by the makers of the image forming apparatus and performs capabilities utilization processing for enabling the reading unit to use the first capabilities and the second capabilities.

### BACKGROUND OF THE INVENTION

### Field of the Invention

The present invention relates to an information processing apparatus that enables image processing apparatuses of a plurality of makers to read an image, a method of controlling the information processing apparatus, and a storage medium.

### Description of the Related Art

An operating system (OS) is installed in a personal computer in advance. The OS has functions for basic management and control of the personal computer, and the like. Further, the personal computer is sometimes communicably connected to, for example, a Multi-Function Peripheral (MFP) having a print function, a scan function, and so forth. To cope with this, the OS has a standard function for causing any MFP of a plurality of makers to execute the print function, the scan function, and the like. Therefore, for example, in a case where execution of a print function uniquely equipped in an MFP of a predetermined maker, i.e. a print function specific to the MFP of the predetermined maker is desired, there is a fear that the OS cannot cope with this, which makes it impossible to execute this specific print function. Further, regardless of whether or not a print function to be executed by the MFP is such a specific print function, the OS acquires capabilities information associated with the print function from the MFP. For the capabilities information, a markup language represented by the Extensible Markup Language (XML) is relatively often used. Japanese Laid-Open Patent Publication (Kokai) No. 2011-258123 discloses a client-server system including a client formed by a personal computer and a server communicably connected to the client. In the client-server system, it is possible to cause a print command to be included in data to be transmitted from the server to the client, as an XML comment line.

However, in a case where execution of a scan function specific to a MFP of a predetermined maker is desired, the client-server system described in Japanese Laid-Open Patent Publication (Kokai) No. 2011-258123 cannot cope with this, which makes it impossible to execute the specific scan function.

### SUMMARY OF THE INVENTION

The present invention provides a system that makes it possible to cause image processing apparatuses of a plurality of makers to read an image and also to cause an image reading operation specific to an image processing apparatus of a predetermined maker to be executed.

In a first aspect of the present invention, there is provided an information processing apparatus that is communicably connected to an image forming apparatus including a reading unit configured to read an image and processes information transmitted and received to and from the image forming apparatus, wherein the image forming apparatus stores, in advance, first information concerning first capabilities which are commonly set by a plurality of makers of the image forming apparatus and can be standardly executed by the reading unit, and second information concerning second capabilities which are uniquely set by a predetermined maker of the image forming apparatus and can be executed by the reading unit, the information processing apparatus including an acquisition unit configured to be capable of acquiring the first information and the second information from the image forming apparatus by using a common protocol commonly set by the plurality of makers of the image forming apparatus, and a processing unit configured to perform capabilities utilization processing for enabling the reading unit to use the first capabilities with which the first information acquired by the acquisition unit is concerned and the second capabilities with which the second information acquired by the acquisition unit is concerned.

In a second aspect of the present invention, there is provided a method of controlling an information processing apparatus that is communicably connected to an image forming apparatus including a reading unit configured to read an image and processes information transmitted and received to and from the image forming apparatus, wherein the image forming apparatus stores, in advance, first information concerning first capabilities which are commonly set by a plurality of makers of the image forming apparatus and can be standardly executed by the reading unit, and second information concerning second capabilities which are uniquely set by a predetermined maker of the image forming apparatus and can be executed by the reading unit, the method including acquiring the first information and the second information from the image forming apparatus by using a common protocol commonly set by the plurality of makers of the image forming apparatus, and performing capabilities utilization processing for enabling the reading unit to use the first capabilities with which the first information acquired by said acquiring is concerned and the second capabilities with which the second information acquired by said acquiring is concerned.

In a third aspect of the present invention, there is provided a non-transitory computer-readable storage medium storing a program for causing a computer to execute a method of controlling an information processing apparatus that is communicably connected to an image forming apparatus including a reading unit configured to read an image and processes information transmitted and received to and from the image forming apparatus, wherein the image forming apparatus stores, in advance, first information concerning first capabilities which are commonly set by a plurality of makers of the image forming apparatus and can be standardly executed by the reading unit, and second information concerning second capabilities which are uniquely set by a predetermined maker of the image forming apparatus and can be executed by the reading unit, the method including acquiring the first information and the second information from the image forming apparatus by using a common protocol commonly set by the plurality of makers of the image forming apparatus, and performing capabilities utilization processing for enabling the reading unit to use the first capabilities with which the first information acquired by said acquiring is concerned and the second capabilities with which the second information acquired by said acquiring is concerned.

According to the present invention, it is possible to cause image processing apparatuses of a plurality of makers to read an image and also to cause an image reading operation specific to an image processing apparatus of a predetermined maker to be executed.

Further features of the present invention will become apparent from the following description of exemplary embodiments (with reference to the attached drawings).

### BRIEF DESCRIPTION OF THE DRAWINGS

FIG. 1 is a diagram showing an example of an image processing system according to a first embodiment.

FIG. 2 is a block diagram showing an example of a hardware configuration of an information processing apparatus.

FIG. 3 is a block diagram showing an example of a hardware configuration of an image processing apparatus.

FIGS. 4A and 4B are block diagrams showing an example of a software configuration of the information processing apparatus.

FIG. 5 is a block diagram showing an example of a software configuration of the image processing apparatus.

FIGS. 6A to 6C are diagrams showing a scanner operation method standardly supported by the information processing apparatus.

FIGS. 7A and 7B are diagrams showing information concerning a reading section of the image processing apparatus.

FIGS. 8A to 8G are diagrams each showing an example of an operation performed with respect to a scanner driver screen.

FIG. 9 is a flowchart of a process commonly performed by image forming apparatuses of a plurality of makers.

FIG. 10 is a flowchart of a process performed by the information processing apparatus.

FIG. 11 is a flowchart showing details (subroutine) of a scanner capabilities acquisition process in a step in FIG. 10.

FIGS. 12A to 12C are diagrams showing information concerning the reading section of the image processing apparatus.

FIG. 13 is a diagram showing the scanner driver screen.

FIG. 14 is a diagram showing an example of an original to be read.

FIG. 15A is a flowchart showing details (subroutine) of the scanner capabilities acquisition process in the step in FIG. 10 in a second embodiment.

FIGS. 15B-A to 15B-C are diagrams showing information concerning the reading section of the image processing apparatus.

FIG. 16A is a flowchart showing details (subroutine) of the scanner capabilities acquisition process in the step in FIG. 10 in a third embodiment.

FIGS. 16B-A to 16B-C are diagrams showing information concerning the reading section of the image processing apparatus.

FIG. 16C is a diagram useful in explaining an example of calculation of address information.

FIG. 17A is a flowchart showing details (subroutine) of the scanner capabilities acquisition process in the step in FIG. 10 in a fourth embodiment.

FIGS. 17B-A to 17B-C are diagrams showing information concerning the reading section of the image processing apparatus.

FIGS. 18A to 18C are diagrams concerning the reading section of the image processing apparatus according to a fifth embodiment.

FIGS. 19A to 19E are diagrams concerning the reading section of the image processing apparatus according to a sixth embodiment.

FIGS. 20A to 20F are diagrams concerning the reading section of the image processing apparatus according to a seventh embodiment.

FIGS. 21A to 21E are diagrams concerning the reading section of the image processing apparatus according to an eighth embodiment.

FIGS. 22A to 22E are diagrams concerning the reading section of the image processing apparatus according to a ninth embodiment.

FIGS. 23A to 23D are diagrams concerning the reading section of the image processing apparatus according to a tenth embodiment.

### DESCRIPTION OF THE EMBODIMENTS

The present invention will now be described in detail below with reference to the accompanying drawings showing embodiments thereof. However, the components described in the following embodiments are described only by way of example, and are by no means intended to limit the scope of the present invention to them alone. For example, each component of the configuration of the present invention can be replaced by a desired component which can exhibit the same function. Further, a desired component can be added. Further, two or more desired configurations (features) of the embodiments can be combined.

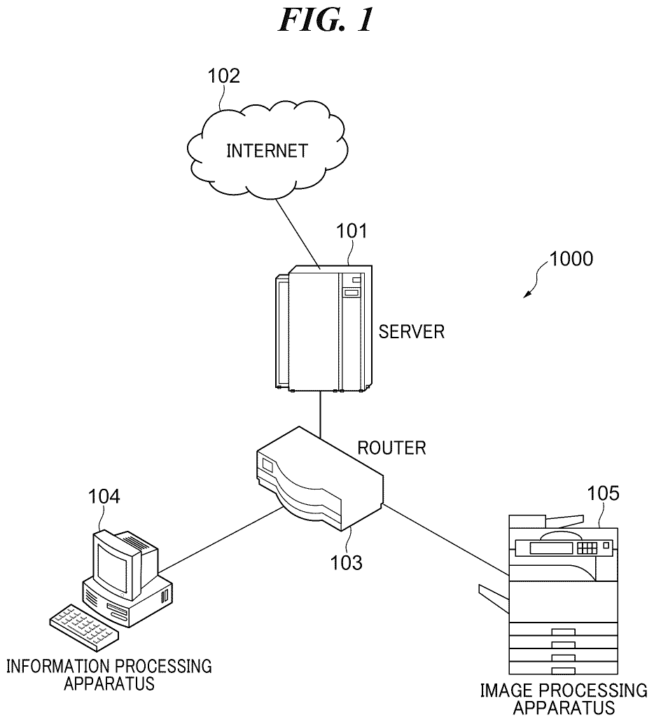

A first embodiment will be described below with reference to FIGS. 1 to 14. FIG. 1 is a diagram showing an example of an image processing system according to the first embodiment. The image processing system, denoted by reference numeral 1000, shown in FIG. 1, includes a server 101, a router 103, an information processing apparatus 104, and an image processing apparatus (image forming apparatus) 105. The server 101, the information processing apparatus 104, and the image processing apparatus 105 are communicably connected to each other via the router 103. Note that this connection method is not particularly limited, but for example, these apparatuses can be wiredly or wirelessly connected. The server 101 is e.g. for controlling an intra-company network. In the present embodiment, the server 101 also has a function of exchanging information between the Internet 102 and the intra-company network. The information processing apparatus 104 is e.g. a desktop-type or laptop type personal computer, a tablet terminal, or a smartphone, and can process information transmitted and received to and from the image processing apparatus 105. The information processing apparatus 104 participates in the intra-company network environment and can access resources on the Internet 102 via the server 101. On the Internet 102, there exist e.g. a site for distributing a printer driver, a scan driver, and so forth of a maker (vendor) of the image processing apparatus 105. The image processing apparatus 105 is e.g. a multi-function peripheral (MFP) having a print function, a copy function, a scan function, a fax function, and so forth, but can be an image forming apparatus having at least the scan function in the present embodiment.

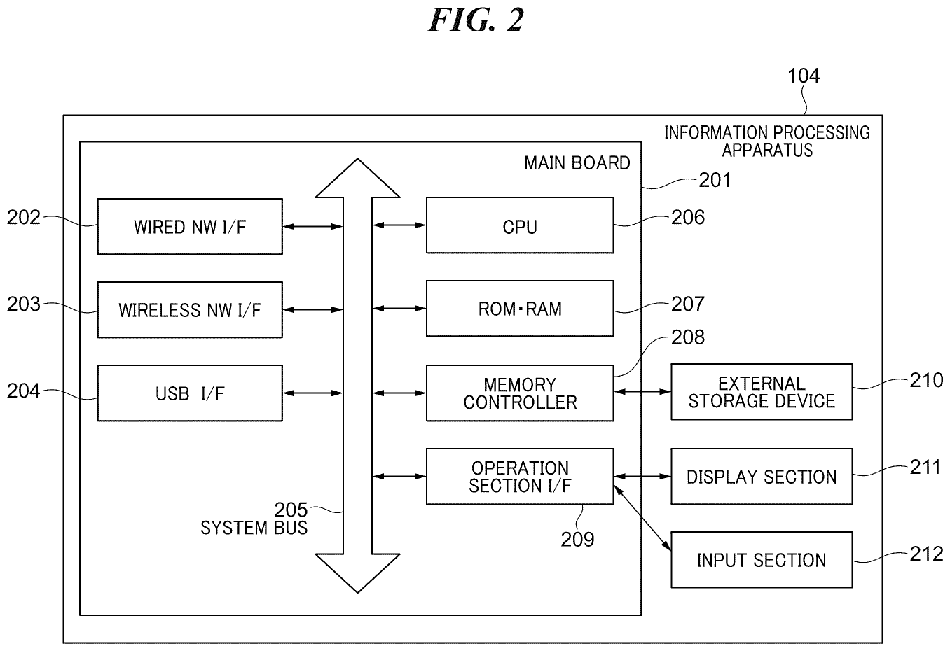

FIG. 2 is a block diagram showing an example of a hardware configuration of the information processing apparatus. As shown in FIG. 2, the information processing apparatus 104 includes a main board 201, an external storage device 210, a display section 211, and an input section 212. The main board 201 is a control board (computer) that controls the overall operation of the information processing apparatus 104. The main board 201 includes a wired network interface (NW I/F) 202, a wireless NW I/F 203, a Universal Serial Bus (USB) I/F 204, a central processing unit (CPU) 206, a read only memory (ROM)-random access memory (RAM) (storage section) 207, a memory controller 208, and a console section I/F 209. These hardware items included in the main board 201 are communicably interconnected via a system bus 205.

The wired NW I/F 202 controls communication of a communication network, such as the Ethernet. The information processing apparatus 104 can communicate with an apparatus on the intra-company network or the Internet 102 via the wired NW I/F 202. The wireless NW I/F 203 mainly controls wireless communication (Wi-Fi (registered trademark) communication) conforming to the IEEE 802.11 series. Further, the wireless NW I/F 203 also functions as an interface with a mobile communication system of Long Term Evolution (LTE), or the like. The information processing apparatus 104 can communicate with an apparatus on the intra-company network or the Internet 102 via the wireless NW I/F 203. Further, the information processing apparatus 104 can also directly access the Internet 102 via a base station of the mobile communication system. To the USB I/F 204, a peripheral device conforming to the USB standard or the like is connected.

The CPU 206 controls the overall operation of the information processing apparatus 104 by executing control programs, such as an operating system and applications, loaded in the ROM-RAM 207. The ROM-RAM 207 has an area for storing a boot program of the information processing apparatus 104 and a storage area for the operation. The memory controller 208 controls transmission and reception of data to and from the external storage device 210. The external storage device 210 has an auxiliary storage area for the ROM-RAM 207. The external storage device 210 is not particularly limited, but for example, a recording medium, such as a hard disk, a USB memory, or an optical memory, can be used. The external storage device 210 stores e.g. programs, temporary data, and files. The programs include, for example, the control programs for causing a computer to execute operations of the components of the information processing apparatus 104 (operations for controlling the information processing apparatus), and further include the operating system (OS) and the applications. To the operation section I/F 209, the display section 211 and the input section 212 are connected. The display section 211 is a display device, such as a liquid crystal panel or an organic electroluminescence (EL) panel, and functions as displaying means for displaying e.g. a variety of information to a user. The input section 212 is an operation device, such as a keyboard, a mouse, and a touch panel incorporated in the display section 211, and functions as receiving means for receiving an operation from a user.

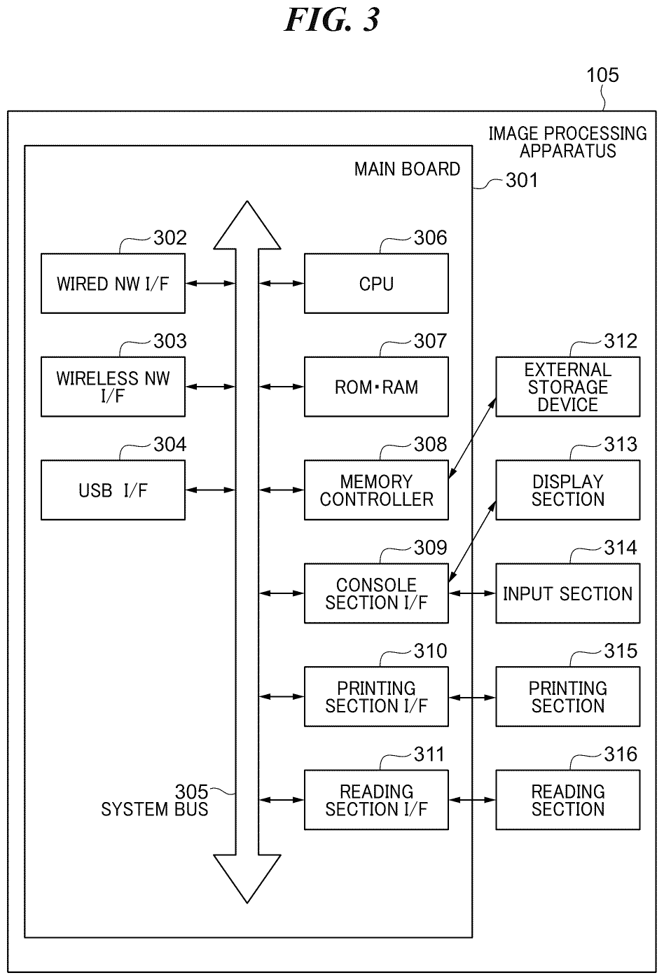

FIG. 3 is a block diagram showing an example of a hardware configuration of the image processing apparatus. As shown in FIG. 3, the image processing apparatus 105 includes a main board 301, an external storage device 312, a display section 313, an input section 314, a printing section 315, and a reading section (reading unit) 316. The main board 301 is a control board that controls the overall operation of the image processing apparatus 105. The main board 301 includes a wired NW I/F 302, a wireless NW I/F 303, a USB I/F 304, a CPU 306, a ROM-RAM (storage section) 307, a memory controller 308, a console section I/F 309, a printing section I/F 310, and a reading section I/F 311. These hardware items included in the main board 301 are communicably interconnected via a system bus 305.

The wired NW I/F 302 controls communication of a wired communication network, such as the Ethernet, and controls communication using a telephone line connected to a telephone line network (not shown). The image processing apparatus 105 can communicate with an apparatus on the intra-company network or the Internet 102 via the wired NW I/F 302. The wireless NW I/F 303 mainly controls wireless communication conforming to the IEEE 802.11 series. Further, the wireless NW I/F 303 also functions as an interface with a mobile communication system of LTE, 5G, or the like. The image processing apparatus 105 can also communicate with an apparatus on the intra-company network or the Internet 102 via the wireless NW I/F 303. Further, the image processing apparatus 105 can also directly access the Internet 102 via a base station of the mobile communication system. Further, in the image processing apparatus 105, in a case where image processing apparatus 105 is connected to the Internet 102, it is possible to select wired connection or wireless connection by using the display section 313 and the input section 314. To the USB I/F 304, e.g. a peripheral device conforming to the USB standard is connected.

The CPU 306 controls the overall operation of the image processing apparatus 105 by executing control programs, such as an operating system and applications, loaded in the ROM-RAM 307. The ROM-RAM 307 has an area for storing a boot program of the image processing apparatus 105, an area for saving an image obtained as a result of reading an original from the reading section 316, and further, a storage area for a variety of operations. The memory controller 308 controls transmission and reception of data to and from the external storage device 312. The external storage device 312 has an auxiliary storage area for the ROM-RAM 307. The external storage device 312 is not particularly limited, but for example, a recording medium, such as a hard disk, a USB memory, or an optical memory, can be used. The external storage device 312 stores e.g. programs, temporary data, and files. The programs include the control programs for causing a computer to execute operations of the components of the image processing apparatus 105, and further include the OS and the applications. To the console section I/F 309, the display section 313 and the input section 314 are connected. The display section 313 is a display device, such as a liquid crystal panel or an organic EL panel, and functions as displaying means for displaying e.g. a variety of information to a user. The input section 314 is an operation device, such as a keyboard, a mouse, and a touch panel incorporated in the display section 313, and functions as receiving means for receiving an operation from a user. To the printing section I/F 310, the printing section 315 is connected, and the printing section I/F 310 transmits print image data to the printing section 315. To the reading section I/F 311, the reading section 316 is connected, and the reading section I/F 311 receives image data from the reading section 316. The printing section 315 is a printer engine and can perform printing by a variety of printing methods, including the electrophotographic method and the inkjet method. The printing section 315 includes sheet feeding cassettes accommodating a plurality of types of sheets, a double-sided printing mechanism, a monochrome/color printing mechanism, a stapling mechanism, a bookbinding mechanism, a trimming mechanism, a shift sorter, and so forth. The reading section 316 is a scanner device and is an image sensor that reads an image form an original. Data of an image (scanned image) read by the reading section 316 is transmitted to the information processing apparatus 104. The reading section 316 includes an automatic document feeder (ADF) that automatically feeds a sheet to be read, and so forth.

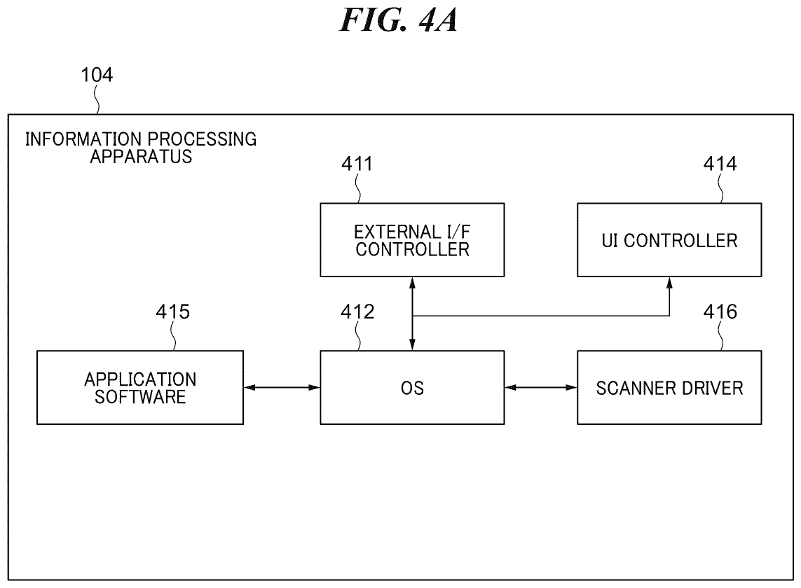

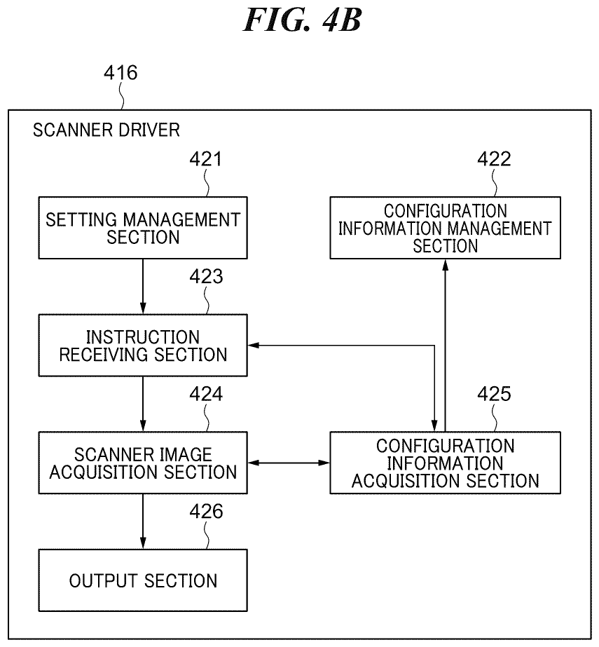

FIGS. 4A and 4B are block diagrams each showing an example of a software configuration of the information processing apparatus. FIG. 4A is a block diagram showing the example of the software configuration of the entire information processing apparatus. FIG. 4B is a block diagram showing an example of a software configuration of a scanner driver included in the information processing apparatus. As shown in FIG. 4A, the information processing apparatus 104 includes an external I/F controller 411, an OS 412, a universal interface (UI) controller 414, application software 415, and a scanner driver 416, and these are software items that operate in a state mainly stored in the ROM-RAM 207. The external I/F controller 411 performs communication with the server 101 by using the wired NW I/F 202 or the wireless NW I/F 203. With this, the information processing apparatus 104 is enabled to access a WEB site of a maker of an image processing apparatus, a WEB site of the maker of the OS, and the like, which exist on the Internet 102. Further, the external I/F controller 411 transmits a scan job to the image processing apparatus 105 and receives a scanned image from the image processing apparatus 105. The UI controller 414 is a part that provides information to a user of the information processing apparatus 104 and receives an instruction from the user via the display section 211 and the input section 212. The OS 412 is an operating system that is stored in the ROM-RAM 207 and controls the overall operation of the information processing apparatus 104. The application software 415 is software e.g. for processing an image. The application software 415 selects the image processing apparatus 105 recognized by the OS 412 and can generate a result of scanning by sending a scan job to the scanner driver 416 and receiving a scanned image from the image processing apparatus 105.

As shown in FIG. 4B, the scanner driver 416 includes a setting management section 421, a configuration information management section 422, an instruction receiving section 423, a scanner image acquisition section 424, a configuration information acquisition section 425, and an output section 426. The setting management section 421 displays an operation mode of the application software 415 and options for the image processing apparatus 105 recognized by the OS 412 on the UI controller 414 and receives an instruction for changing a variety of settings. The configuration information management section 422 determines the capabilities of the reading section 316 associated with the image processing apparatus 105 selected by the setting management section 421 and holds and manages the determined capabilities. The instruction receiving section 423 receives e.g. an event that the image processing apparatus 105 recognized by the OS 412 has been selected and an event that a scan job has been transmitted to the scanner driver 416, and executes processing corresponding to each event. In a case where an instruction for acquiring image data is provided from the application software 415 to the scanner driver 416, the scanner image acquisition section 424 issues the acquisition instruction to the image processing apparatus 105 and thereby obtains a scanned image from the image processing apparatus 105. In a case where the instruction receiving section 423 receives an event that the image processing apparatus 105 recognized by the OS 412 has been selected, the configuration information acquisition section 425 acquires the basic capabilities of the reading section 316 from the image processing apparatus 105, based on an instruction from the instruction receiving section 423. The basic capabilities are first capabilities, described hereinafter. Further, the configuration information acquisition section 425 acquires capabilities specific to the reading section 316 from the image processing apparatus 105 as required. The specific capabilities are second capabilities, described hereinafter. Information concerning the capabilities acquired by the configuration information acquisition section 425 is managed by the configuration information management section 422. The output section 426 outputs image data acquired by the scanner driver 416 and transmits the image data to the application software 415.

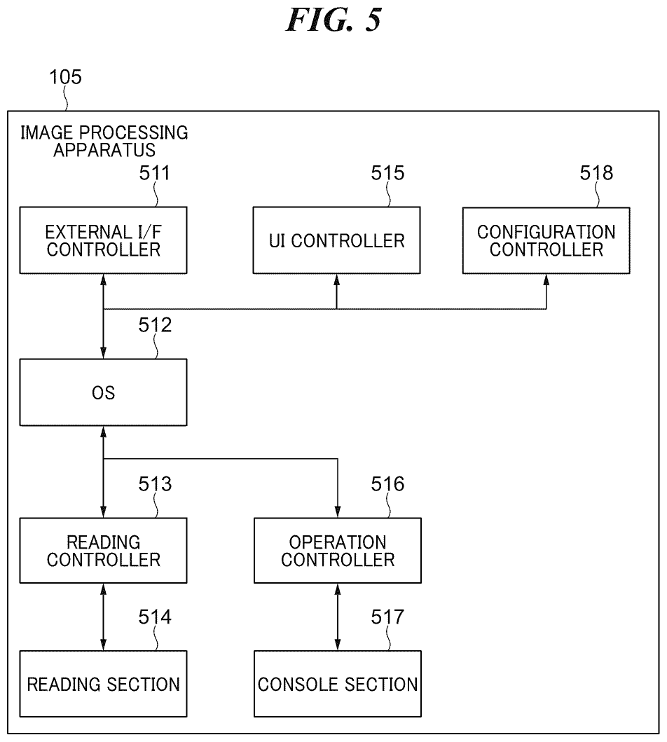

FIG. 5 is a block diagram showing an example of a software configuration of the image processing apparatus. As shown in FIG. 5, the image processing apparatus 105 includes an external I/F controller (image processing apparatus external I/F controller) 511, an OS (image processing apparatus OS) 512, a reading controller 513, and a reading section 514. Further, the image processing apparatus 105 includes a UI controller (image processing apparatus UI controller) 515, an operation controller 516, a console section 517, and a configuration controller (image processing apparatus configuration controller) 518. These software items included in the image processing apparatus 105 operate in a state mainly stored in the ROM-RAM 307. The external I/F controller 511 receives a scan job from the information processing apparatus 104 and transmits data of a scanned image (scan data) to the information processing apparatus 104 by using the wired NW I/F 302 or the wireless NW I/F 303. The OS 512 is an operating system that is stored in the ROM-RAM 307 and controls the overall operation of the image processing apparatus 105. Further, the OS 512 can also exchange information between the software items on the image processing apparatus 105 and perform execution control. The reading controller 513 acquires image information from the reading section 514 based on a scan job transmitted to the reading controller 513 via the wired NW I/F 302, the wireless NW I/F 303, or the USB I/F 304. The reading section 514 is a scanner driver and sends image information read by the scanner driver to the reading controller 513. The UI controller 515 is a part that provides information to a user of the image processing apparatus 105 and receives an instruction from the user via the display section 313 and the input section 314. The operation controller 516 switches the functions in a case where the image processing apparatus 105 is a multi-function peripheral having the plurality of functions as described above. The console section 517 performs, in a case where the image processing apparatus 105 is a multi-function peripheral, processing suitable for each function. The configuration controller 518 manages information concerning the reading section 514 and holds the information as the scanner capabilities. As the scanner capabilities, for example, two types of capabilities are included. The first type of capabilities are the first capabilities that are commonly set by a plurality of makers of the image processing apparatus 105 and can be standardly executed by the reading section 316 of the image processing apparatus 105 of each maker. Information concerning the first capabilities is hereinafter referred to as the “first information”. The second type of capabilities are the second capabilities that are uniquely set by a predetermined maker of the image processing apparatus 105 and can be executed by the reading section 316 of the image processing apparatus 105 of the predetermined maker. Information concerning this second type of capabilities are hereinafter referred to as the “second information”. In the present embodiment, the first information and the second information are stored e.g. in the ROM-RAM 307 in advance. The first information and the second information are acquired by the configuration information acquisition section 425 of the information processing apparatus 104 and are managed by the configuration information management section 422.

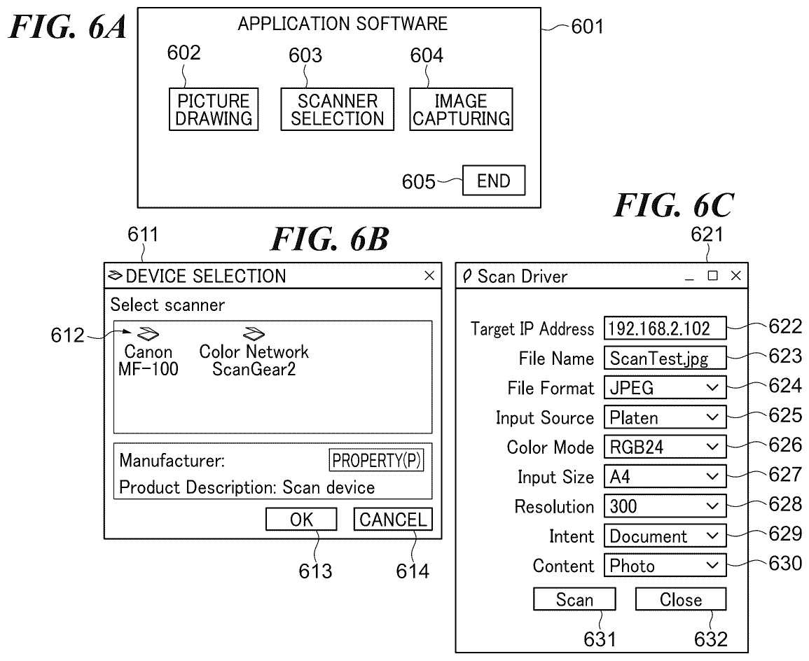

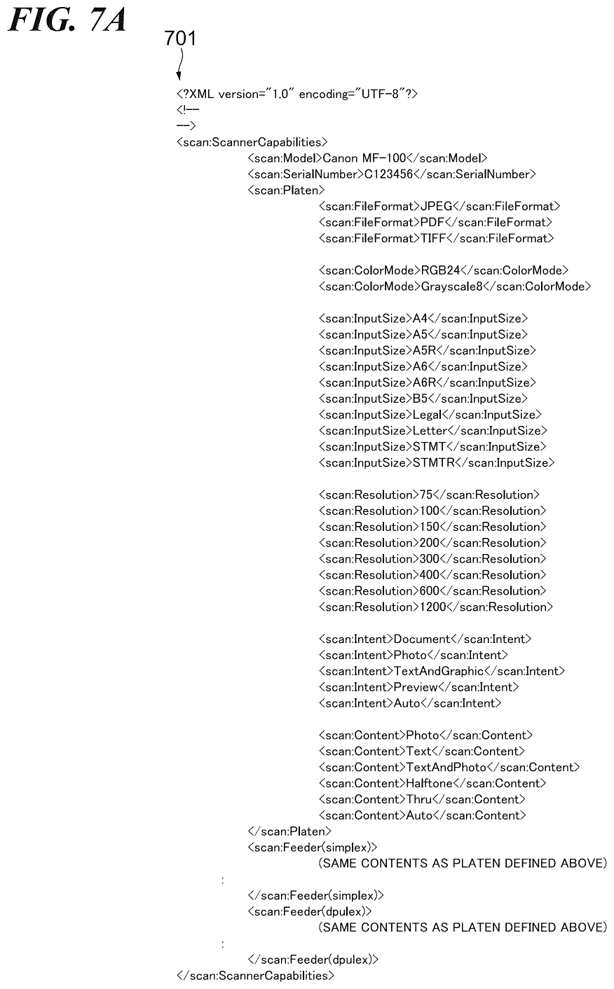

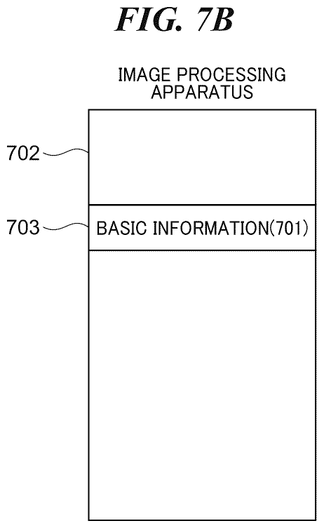

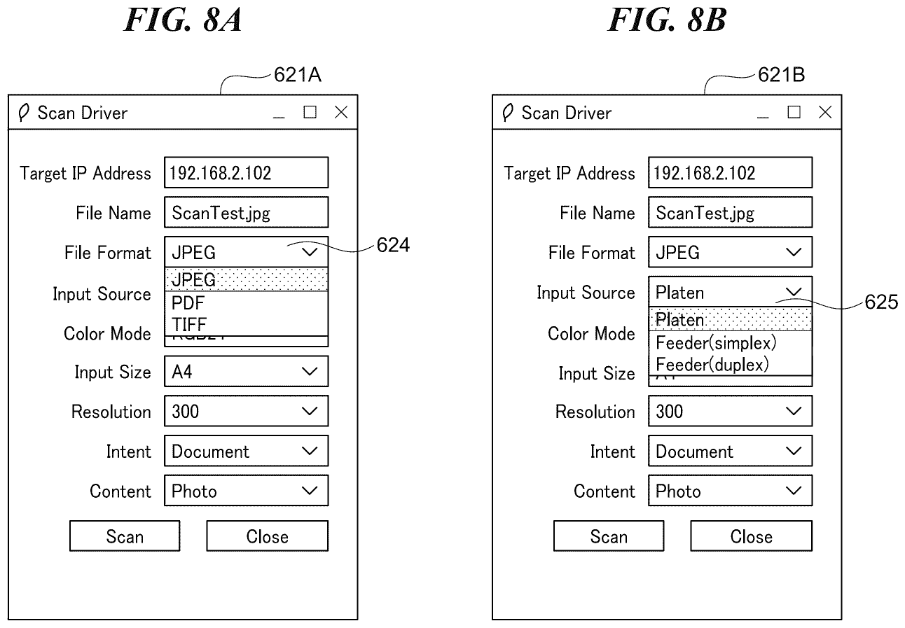

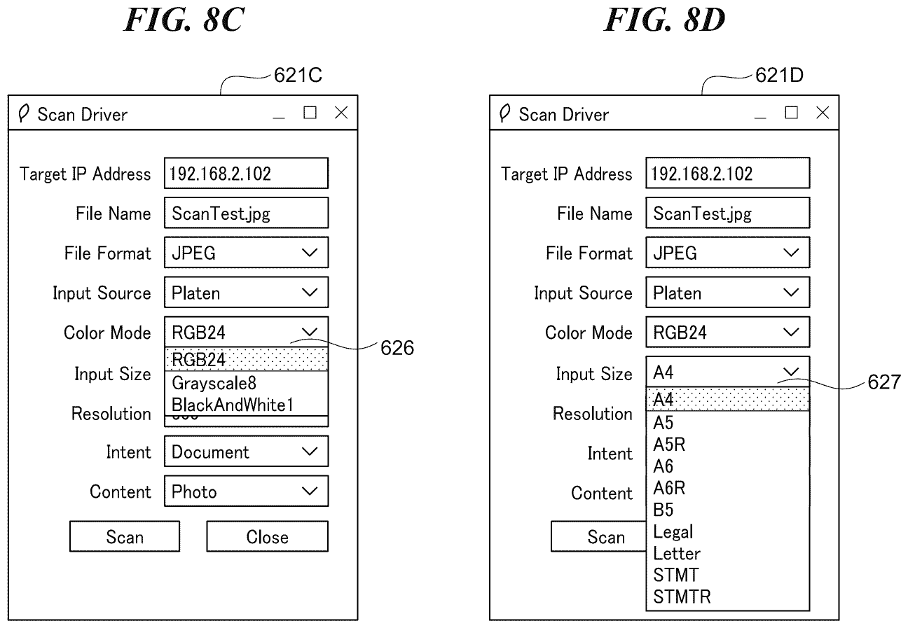

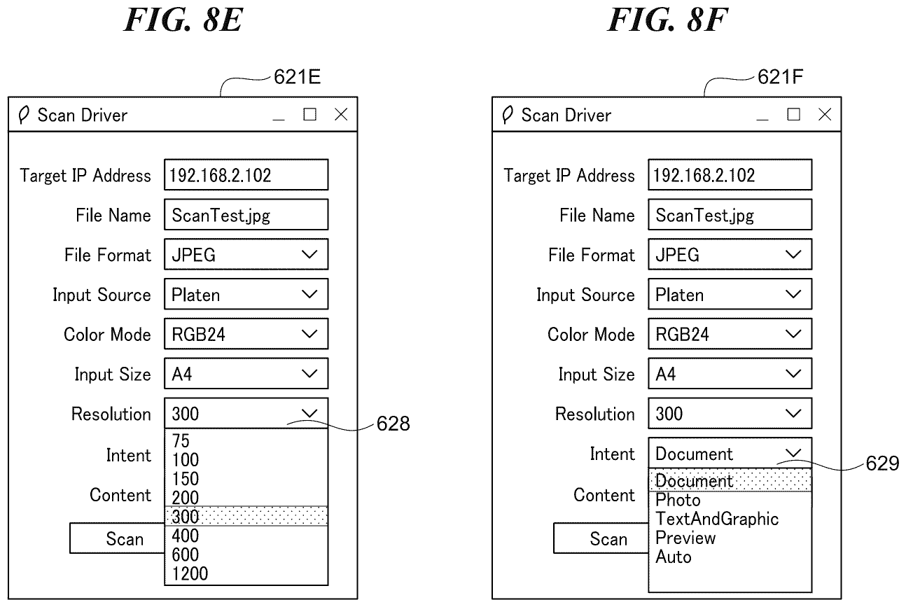

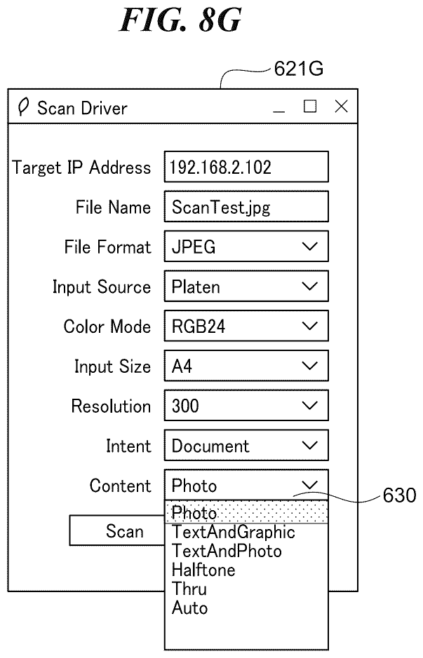

FIGS. 6A to 6C are diagrams each showing an example of a screen displayed on the display section of the information processing apparatus. FIG. 6A shows an application software screen. FIG. 6B shows a scanner selection screen. FIG. 6C shows a scanner driver screen. FIGS. 7A and 7B are diagrams showing information concerning the reading section of the image processing apparatus. FIG. 7A is a diagram showing the scanner capabilities of the reading section of the image processing apparatus. FIG. 7B is a diagram showing a memory map of the ROM-RAM of the image processing apparatus. FIGS. 8A to 8G are diagrams each showing an example of an operation performed with respect to a scanner driver screen. FIGS. 8A to 8G are diagrams each showing an example of an operation performed with respect to each operation area included in the scanner driver screen. The application software screen denoted by reference numeral 601, shown in FIG. 6A, includes a button 602, a button 603, a button 604, and a button 605. Note that the buttons included in the application software screen 601 are not limited to the buttons 602 to 605. The button 602 is operated to draw a picture. When the button 602 is operated, a drawing screen (not shown) is displayed on the display section 211 and the user is enabled to draw a picture. This picture can be saved. The button 605 is operated to terminate the application software 601.

The button 603 is operated to select a scanner. When the button 603 is operated, the scanner selection screen denoted by reference numeral 611, shown in FIG. 6B, is displayed on the display section 211. The scanner selection screen 611 includes icons 612, a button 613, and a button 614. One of the icons 612 indicates the image processing apparatus 105 registered in the OS 412 in advance and is selectable. When this icon 612 is selected and the button 613 is operated, the use of the image processing apparatus 105 indicated by the icon 612 is determined. After that, the scanner selection screen 611 is closed, and the screen is returned to the state in which the application software screen 601 is displayed again. At this time, the OS 412 requests the image processing apparatus 105 to provide the scanner capabilities, i.e. information concerning the reading section 514 of the image processing apparatus 105. The image processing apparatus 105 having received this request provides e.g. information 701 shown in FIG. 7A as the information concerning the reading section 316 (reading section 514) of the image processing apparatus 105. The information 701 is described in a markup language, such as the Extensible Markup Language (XML). The memory map denoted by reference numeral 702, shown in FIG. 7B, is a memory map of the ROM-RAM 307 of the image processing apparatus 105. In the memory map 702, the information concerning the reading section 316 is stored in an area 703 as the first information (basic information). In the present embodiment, the first information is the information 701. In a case where a request for providing the scanner capabilities is transmitted from the OS 412 to the IP address of the image processing apparatus 105 on the network, the image processing apparatus 105 transmits the information 701 stored in the area 703 as the first information as a response. Note that in a case where the button 614 is operated without selecting any icon 612, the scanner selection screen 611 is closed without determining the use of the image processing apparatus 105 indicated by the icon 612, and the screen returns to the state in which the application software 601 is displayed.

The button 604 is operated to capture an image. When the button 604 is operated, the scanner driver screen denoted by reference numeral 621, shown in FIG. 6C, is displayed on the display section 211. The scanner driver screen 621 includes an operation area 622, an operation area 623, an operation area 624, an operation area 625, an operation area 626, an operation area 627, an operation area 628, an operation area 629, an operation area 630, a button 631, and a button 632. In the operation areas 624 to 630, it is possible to select a first capability (common function) which can be executed by the reading section 316. The operation area 622 is an area for displaying the IP Address (target IP Address) indicating the address of the image processing apparatus 105 on the network, indicated by the one of the icons 612 selected by operating the button 603, as reference information. The operation area 623 is an area for displaying a file name of an image read by the reading section 316 at the time of saving thereof. Note that, by inputting a desired file name from the input section 212, the file name in the operation area 623 can be updated to the desired file name.

The operation area 624 is an area for selecting a format of an image read by the reading section 316. On a scanner driver screen 621A, shown in FIG. 8A, “JPEG” is selected from “JPEG”, “PDF”, and “TIFF” included in the operation area 624 as the options. The operation area 625 is an area for switching a reading method used by the reading section 316. The reading section 316 has an original platen glass and a feeder (ADF) that dynamically feeds a sheet to be read. From the operation area 625, it is possible to select whether to use the original platen glass (Platen) or the feeder (Feeder) to read an original. Further, in the operation area 625, in a case where the feeder is used, it is possible to further select one-side reading (simplex) or both-sides reading (duplex). On a scanner driver screen 621B, shown in FIG. 8B, “Platen” is selected from “Platen”, “Feeder (simplex)”, and “Feeder (duplex)”, included in the operation area 625 as the options. The operation area 626 is an area for switching color information of an image read by the reading section 316. On a scanner driver screen 621C, shown in FIG. 8C, “RGB 24” is selected from “RGB 24”, “Gray Scale 8” and “Black And White 1”, included in the operation area 626 as the options. The “RGB 24” refers to expression of each dot by using a total of 24 bits, formed by 8 bits (256 gradations) for Red, 8 bits (256 gradations) for Green, and 8 bits (256 gradations) for Blue. The “Gray Scale 8” refers to expression of each dot by using 8 bits (256 gradations) for brightness-darkness information. The “Black And White 1” refers to expression of each dot by using 1 bit (2 gradations).

The operation area 627 is an area for switching the size of an image read by the reading section 316. On a scanner driver screen 621D, shown in FIG. 8D, “A4” is selected from “A4”, “A5” and so forth, included in the operation area 627 as the options. The operation area 628 is an area for switching the resolution of the reading section 316. On a scanner driver screen 621E, shown in FIG. 8E, “300” is selected from “75”, “300”, “1200”, and so forth, included in the operation area 628 as the options. In general, the resolution is described as the number of dots per one inch. The operation area 629 is an area for switching the use purpose of an image read by the reading section 316. On a scanner driver screen 621F, shown in FIG. 8F, “Document” is selected from “Document”, “Photo”, “Text And Graphic”, “Preview”, and “Auto”, included in the operation area 629 as the options. Note that the “Text And Graphic” refers to an image in which characters are mixed with a photo or photos. The “Auto” refers to automatic setting. The operation area 630 is an area for switching the type of an original set on the reading section 316. On a scanner driver screen 621G, shown in FIG. 8G, “Photo” is selected from “Photo”, “Text”, “Text And Graphic”, “Halftone”, “Thru”, and “Auto”, included in the operation area 630 as the options. Note that the “Thru” refers to an image which is not required to be processed. In the image processing apparatus 105, it is possible to select an optimum image processing method by combining switching on the operation area 629 and switching on the operation area 630. When the button 631 is operated, the reading section 316 optically reads an original set on the reading section 316, converts the read image to data, and provides the image data to the information processing apparatus 104. Further, when the button 632 is operated, the scanner driver screen 621 is closed, and the display returns to a state in which the application software screen 601 is displayed again.

As mentioned above, in the present embodiment, the scanner capabilities include the first capabilities and the second capabilities. The first capabilities are commonly set by a plurality of makers of the image processing apparatus 105 and can be standardly executed by the reading sections 316 of the image processing apparatuses 105 of the plurality of makers. The information concerning the first capabilities is the first information. The second capabilities are uniquely set by a predetermined maker of the image processing apparatus 105 and can be executed by the reading sections 316 of the image processing apparatuses 105 of the predetermined maker. The information concerning the second capabilities is the second information. Therefore, the image processing apparatuses 105 of the plurality of makers can commonly execute the first capabilities. On the other hand, in execution of the second capabilities, the situation is different. Specifically, there is a fear that although the image processing apparatus 105 of one maker A can execute the second capabilities, the image processing apparatus 105 of a maker B which is different from the maker A cannot cope with execution of the second capabilities, i.e. cannot execute the second capabilities.

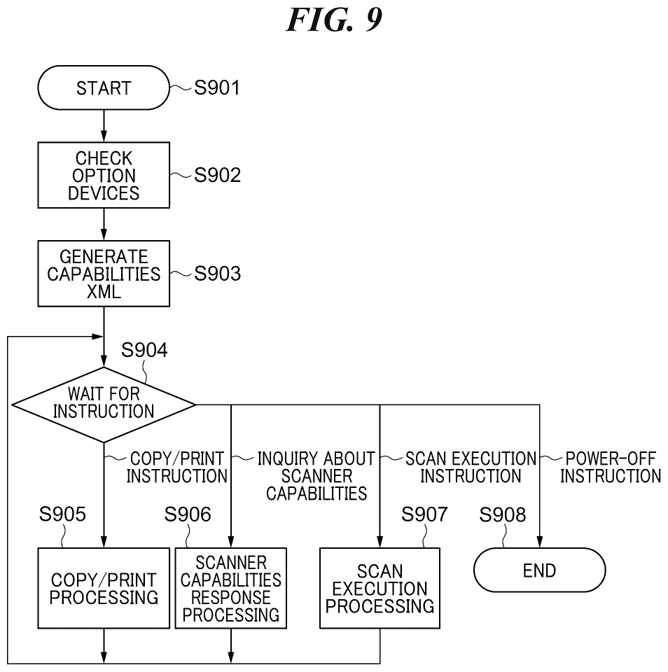

In view of this, the present embodiment makes it possible to reduce occurrence of such situation. The configuration and effects of the present embodiment will be described below. FIG. 9 is a flowchart of a process commonly performed by the image forming apparatuses of the plurality of makers. As shown in FIG. 9, in a step S901, the image processing apparatus 105 is powered on to enable the image processing apparatus 105 to operate, and the process is started.

In a step S902, the OS 512 of the image processing apparatus 105 instructs the configuration controller 518 to check the configuration of a variety of option devices forming the reading section 316. For example, the OS 512 checks presence/absence of the following components and so forth, as the configuration of the option devices of the reading section 316: The first check point is presence/absence of the original platen glass for laying an original to be read one by one and optically reading the original. The second check point is presence/absence of the ADF that automatically optically reads original sheets one by one by collectively setting the original sheets on a sheet feeding port in a bundle state. The third check point is whether the ADF reads one side of the original or both sides of the original. The fourth check point is whether or not the ADF can cope with long paper which exceeds a standard size, such as A-size or B-size. Then, the OS 512 determines whether the configuration of each option device can be regarded as one of the first capabilities or one of the second capabilities and stores a result of the determination (the first information or the second information) in the ROM-RAM 307 in a state referable when capabilities XML is generated. After execution of the step S902, the process proceeds to a step S903.

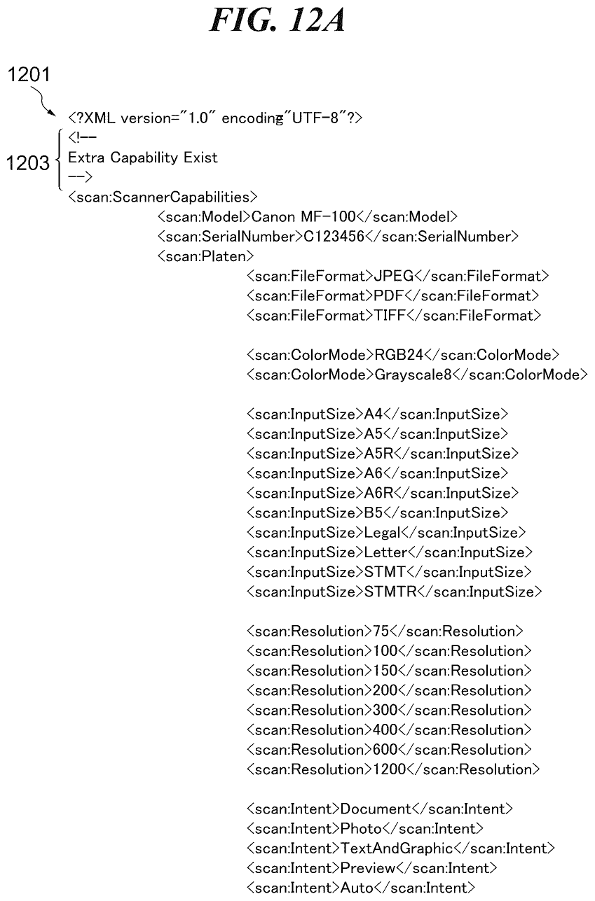

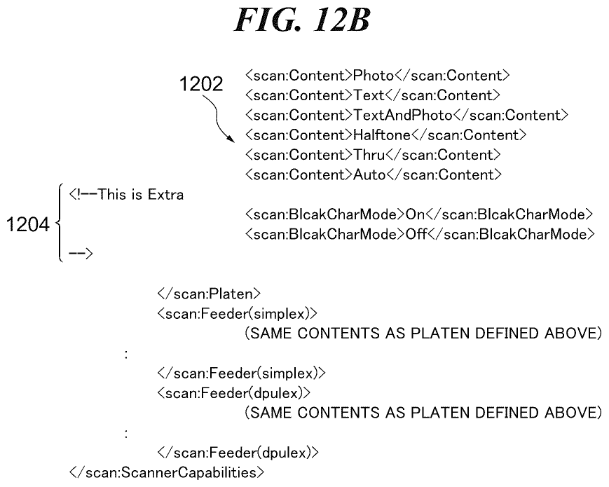

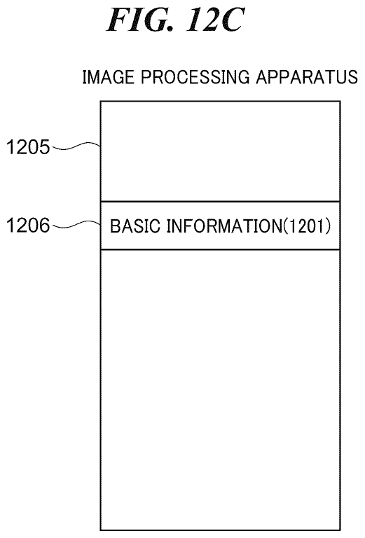

In the step S903, the OS 512 instructs the configuration controller 518 to generate capabilities XML, which expresses the first information and the second information, which is stored in the step S902, in the markup language. The capabilities XML is stored in the ROM-RAM 307. Note that in a case where the information stored in the step S902 is only the first information out of the first information and the second information, the information 701 shown in FIG. 7A is generated as the capabilities XML. On the other hand, in a case where the information stored in the step S902 is both of the first information and the second information, information 1201 shown in FIG. 12A and information 1202 shown in FIG. 12B are generated as the capabilities XML. Note that FIGS. 12A and 12B are separately illustrated because of the drawing layout. Further, a memory map 1205 shown in FIG. 12C is a memory map of the ROM-RAM 307 of the image processing apparatus 105. In the memory map 1205, the information concerning the reading section 316 is stored in an area 1206 as the first information (information 1201).

In a step S904, the OS 512 waits for an instruction to be provided from the user to the image processing apparatus 105. As the instruction-waiting state, for example, in a case where the image processing apparatus 105 is a multi-function peripheral, information to the effect that the image processing apparatus 105 is in the state of waiting for an instruction can be displayed on the display section 313, or information to the effect that the image processing apparatus 105 is in the state of waiting for an instruction concerning scan from the information processing apparatus 104 can be displayed. Then, one of steps S905 to 908 is executed according to the instruction.

In the step S905, if a copy or print instruction to the image processing apparatus 105 is received in the step S904, the OS 512 instructs the printing section 315 to execute copy or print processing. After execution of the step S905, the process returns to the step S904, and the step S904 et seq. are sequentially executed.

In the step S906, if an inquiry about the scanner capabilities to the image processing apparatus 105 is received in the step S904, the OS 512 transmits the capabilities XML generated in the step S903 to the information processing apparatus 104 as a response. After execution of the step S906, the process returns to the step S904, and the step S904 et seq. are sequentially executed.

In the step S907, if a scan instruction to the image processing apparatus 105 is received in the step S904, the OS 512 instructs the reading section 316 to execute scan processing according to the capabilities XML generated in the step 903 and a scan execution-requesting job. Then, the OS 512 transmits image data acquired by execution of the scan processing to the information processing apparatus 104. After execution of the step S907, the process returns to the step S904, and the step S904 et seq. are sequentially executed.

In the step S908, if an instruction for shifting the image processing apparatus 105 to a power-off state has been received in the step S904, the OS 512 shifts the image processing apparatus 105 to an operation stop state, followed by terminating the process.

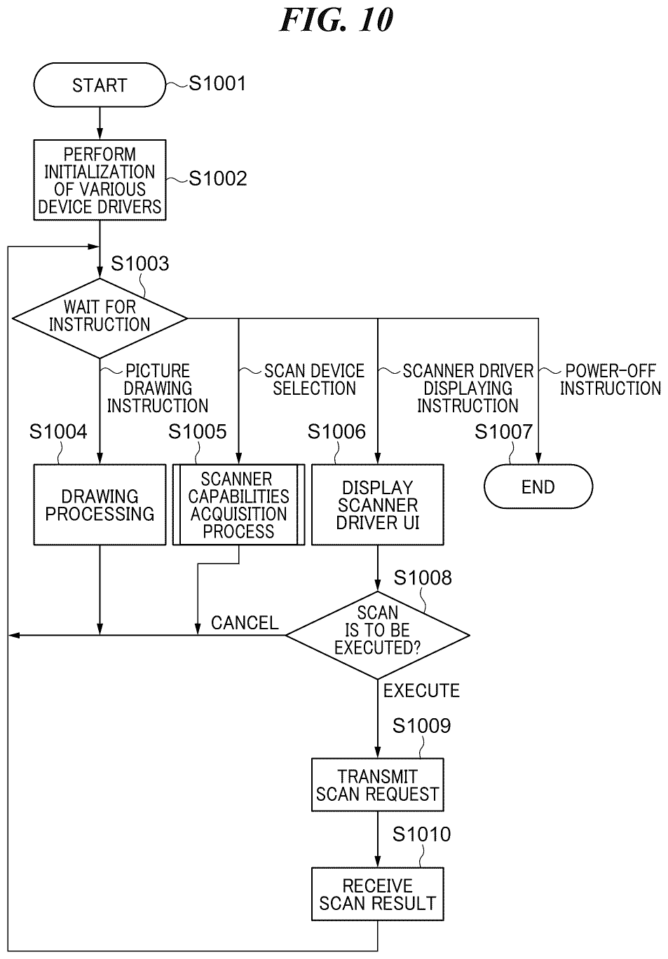

FIG. 10 is a flowchart of a process performed by the information processing apparatus. As shown in FIG. 10, in a step S1001, the information processing apparatus 104 is powered on to enable the information processing apparatus 104 to operate, and the process is started.

In a step S1002, the OS 412 of the information processing apparatus 104 performs processing for initializing the OS 412 itself and processing for initializing a variety of device drivers, including the scanner driver 416. With this, the information processing apparatus 104 is made available for use. After the initialization, the OS 412 starts e.g. the application software 415. At this time, on the display section 211, a screen indicating that the application software 415 has been started (application software screen 601) is displayed. After execution of the step S1002, the process proceeds to a step S1003.

In the step S1003, the application software 415 waits for an instruction from the user via the input section 212. Then, one of steps S1004 to S1007 is executed according to the instruction.

In the step S1004, if the button 602 on the application software screen 601 is operated on the application software screen 601 in the step S1003, the application software 415 displays the drawing screen (not shown) on the display section 211. Note that the button 602 is the button operated when drawing a picture. Then, after a picture has been drawn on the drawing screen, data of this picture is stored e.g. in the external storage device 210. After execution of the step S1004, the process returns to the step S1003, and the step S1003 et seq. are sequentially executed.

In the step S1005, if the button 603 on the application software screen 601 is operated in the step S1003, the application software 415 displays the scanner selection screen 611, shown in FIG. 6B, on the display section 211. Note that the button 603 is the button operated when selecting a scanner. Then, in a case where the one of the icons 612 and the button 613 on the scanner selection screen 611 have been sequentially operated, the OS 412 instructs the scanner driver 416 to execute an acquisition process for acquiring the scanner capabilities of the image processing apparatus 105 indicated by the one of the icon 612. The configuration information management section 422 of the information processing apparatus 104 stores the scanner capabilities, i.e. the capabilities XML acquired by the acquisition process in the ROM-RAM 207. After execution of the step S1005, the process returns to the step S1003, and the step S1003 et seq. are sequentially executed.

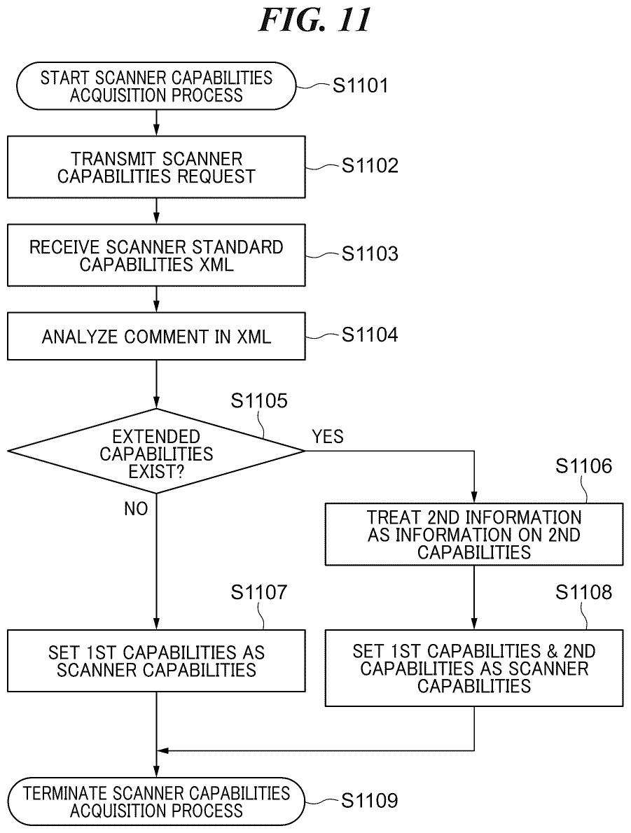

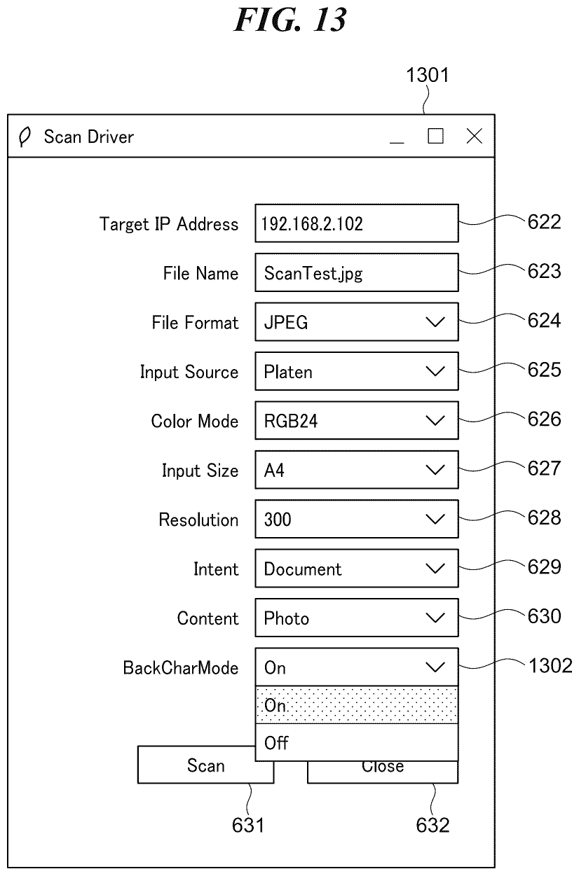

FIG. 11 is a flowchart showing details (subroutine) of the scanner capabilities acquisition process in the step S1005 in FIG. 10. FIGS. 12A to 12C are diagrams showing information concerning the reading section of the image processing apparatus. FIG. 12A is a diagram showing the first capabilities which can be executed by the reading section of the image processing apparatus. FIG. 12B is a diagram showing the second capabilities which can be executed by the reading section of the image processing apparatus. FIG. 12C is a diagram showing a memory map of the ROM-RAM of the image processing apparatus. FIG. 13 is a diagram showing the scanner driver screen. As shown in FIG. 11, in a step S1101, the scanner capabilities acquisition process is started.

In a step S1102, the configuration information acquisition section 425 of the information processing apparatus 104 (scanner driver 416) transmits a request for acquiring the scanner capabilities to the address of the image processing apparatus 105 on the network. In a case where the scanner capabilities request is received, the image processing apparatus 105 can transmit the scanner capabilities to the scanner driver 416.

In a step S1103, the configuration information acquisition section 425 (acquisition unit) temporarily receives the scanner capabilities, i.e. the capabilities XML from the image processing apparatus 105 as the information (first information) of the scanner standard capabilities (first capabilities). With this, the configuration information acquisition section 425 can acquire the first information. Note that this acquisition is performed by using a common protocol commonly set by the plurality of makers of the image processing apparatus 105. The common protocol is not particularly limited, and for example, a communication protocol, such as eSCL protocol, can be used.

In a step S1104, the configuration information acquisition section 425 analyzes comment lines included in the first information (capabilities XML) acquired in the step S1103. Note that in the XML, a sentence from “<!--” to “-->” is treated as a comment by the grammar of the XML.

In a step S1105, as a result of the analysis in the step S1104, the configuration information acquisition section 425 (determination unit) determines whether or not the second information exists in the first information, i.e. whether or not the second capabilities which can be executed by the image processing apparatus 105 exist. Here, a case where the configuration information acquisition section 425 has received the information 1201 shown in FIG. 12A and the information 1202 shown in FIG. 12B as the capabilities XML in the step S1103 will be described by way of example. The information 1201 includes a comment 1203 and the information 1202 includes a comment 1204. Then, in a case where the configuration information acquisition section 425 analyzes the information 1201 from its top and detects a keyword “Extra Capability Exist” from the comment 1203, it is determined that the second information exists, and the process proceeds to a step S1106. On the other hand, in a case where the configuration information acquisition section 425 analyzes the information 1201 from its top and does not detect the keyword “Extra Capability Exist” from the comment 1203, it is determined that the second information does not exist, and the process proceeds to a step S1107. Thus, in the present embodiment, the information 1201 and the information 1202 collectively form the first information, and the second information is included in the first information. Further, presence/absence of the second information can be determined based on the XML. Note that the keyword is “Extra Capability Exist” in the present embodiment but is not limited to this.

In the step S1106, the configuration information acquisition section 425 interprets the comment 1204 not as a comment. With this, the description in the comment 1204 is treated as the second capabilities (extended capabilities). Thus, in the present embodiment, the second information in the first information is expressed as a comment between “<!--” and “-->” by the grammar of the XML and is in a state temporarily invalidated. Then, in a case where the second information is interpreted to be not a comment, the second information is treated as the information concerning the second capabilities.

In the step S1107, the configuration information acquisition section 425 treats the first capabilities as the capabilities which can be standardly executed by the reading section 316. In this case, for example, the first information concerning the first capabilities is the information 701 shown in FIG. 7A. After execution of the step S1107, the process proceeds to a step S1109.

In a step S1108, the configuration information acquisition section 425 treats the second capabilities as the capabilities which can be uniquely executed by the reading section 316. Further, the configuration information acquisition section 425 treats not only the second capabilities, but also the first capabilities as the capabilities which can be executed by the reading section 316. After execution of the step S1108, the process proceeds to the step S1109.

In the step S1109, the configuration information management section 422 stores the information acquired before the step S1109 in the ROM-RAM 207, followed by terminating the process.

Referring again to FIG. 10, in the step S1006, in a case where the button 604 on the application software screen 601 is operated in the step S1003, the application software 415 (processing unit) displays the scanner driver screen on the display section 211. This scanner driver screen includes the above-mentioned scanner driver screen 621 shown in FIG. 6C and a scanner driver screen 1301 shown in FIG. 13. In a case where the information 701, i.e. only the first information has been transmitted from the image processing apparatus 105, the scanner driver screen 621 is displayed. On the other hand, in a case where the information 1201 and the information 1202, i.e. the first information including the second information has been transmitted from the image processing apparatus 105, the scanner driver screen 1301 is displayed. Similar to the scanner driver screen 621, the scanner driver screen 1301 includes the operation area 622 to the button 632. In the operation areas 624 to 630, the execution conditions of the first capabilities can be selected. The scanner driver screen 1301 further includes an operation area 1302. The operation area 1302 is an area for selecting whether or not to execute ridge line emphasis processing for emphasizing, when an original is read by the reading section 316, a ridge line of a black character included in an image of the original to make the appearance of the character clear. The capability of executing the ridge line emphasis processing is not a first capability but a second capability. Therefore, in the operation area 1302, it is possible to select the execution condition of the second capability. In the state shown in FIG. 13, “ON” is selected from “ON (execute the ridge line emphasis processing)” and “OFF (not execute the ridge line emphasis processing)”, included in the operation area 1302 as the options. Thus, in a case where the first information and the second information have been acquired, it is possible to perform capabilities utilization processing for making the first capabilities and the second capabilities available in the reading section 316. As this processing step, processing is performed for displaying the scanner driver screen 1301 on which the execution conditions of the first capabilities and the second capabilities are selectable. This enables the reading section 316 to execute the first capabilities and the second capabilities. Note that in the present embodiment, the processing step is the processing for displaying the scanner driver screen 1301 but is not limited to this.

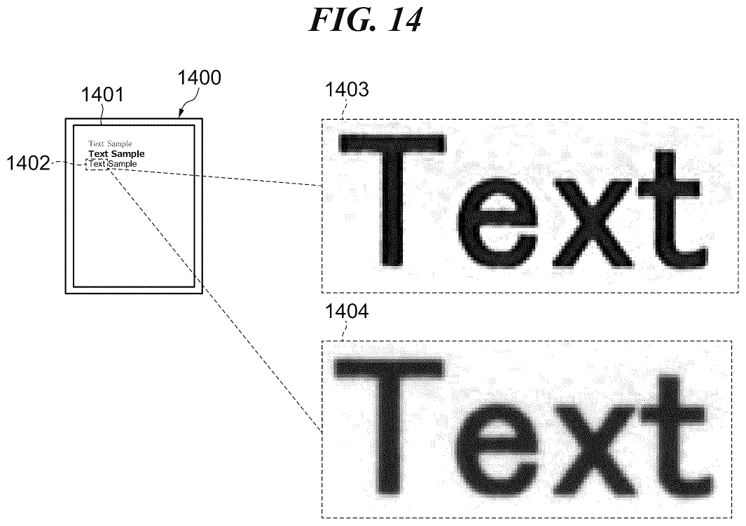

Here, the ridge line emphasis processing will be described with reference to FIG. 14. FIG. 14 is a diagram showing an example of an original to be read. As shown in FIG. 14, an original 1400 is one formed by printing black characters on a rectangular print sheet. From the original 1400, an inside rectangular image readable range 1401 is read by the reading section 316. In a case where an area 1402 including part of the black characters in the image readable range 1401 is enlarged, an enlarged view 1403 or an enlarged view 1404 is obtained. The enlarged view 1403 is a view obtained in a case where the ridge line emphasis processing has been executed. The enlarged view 1404 is a view obtained in a case where the ridge line emphasis processing has not been executed. When comparing the enlarged view 1403 and the enlarged view 1404, it is understood that the ridge lines of the black characters are more emphasized and the appearance of the characters is clearer in the enlarged view 1403 than in the enlarged view 1404.

Referring again to FIG. 10, in a step S1008, even when either of the scanner driver screen 621 or the scanner driver screen 1301 is displayed in the step S1007, the application software 415 waits for an instruction from the user, which is provided on the displayed screen. Then, the application software 415 determines whether or not the button 631 on the displayed screen has been operated, i.e. an instruction for reading (scanning) an original in the reading section 316 has been provided. As a result of this determination, if it is determined that the button 631 has been operated, the process proceeds to a step S1009. On the other hand, if it is determined that the button 631 has not been operated but the button 632 has been operated, the application software 415 closes the screen, and the process returns to the step S1003, and the step S1003 et seq. are sequentially executed. Note that in a case where the setting in any of the operation areas 624 to 630 is changed, the changed contents are saved in the ROM-RAM 207.

In the step S1009, the application software 415 generates setting items of the respective operation areas, which are stored in the ROM-RAM 207, in the same format of the capabilities XML, and transmits, as a scan request, the generated setting items to the image processing apparatus 105 together with the scan instruction received in the step S1008. With this, the image processing apparatus 105 can execute processing for reading the original by operating the reading section 316 according to the instruction received in the step S1009. Then, the image processing apparatus 105 converts an image read from the original to data and transmits the data to the information processing apparatus 104. After execution of the step S1009, the process proceeds to a step S1010.

In the step S1010, the scanner image acquisition section 424 acquires the image data from the image processing apparatus 105. The output section 426 transmits the image data to the application software 415. After execution of the step S1010, the process returns to the step S1003, and the step S1003 et seq. are sequentially executed.

In the step S1007, if the instruction for shifting the information processing apparatus 104 to the power-off state has been received in the step S1003, the OS 412 shifts the information processing apparatus 104 to the operation stop state, followed by terminating the process.

As described above, in the information processing apparatus 104, by acquiring the first information by using the common protocol, it is possible to cause the image processing apparatuses 105 of the plurality of makers to commonly perform image reading, i.e. execute the first capabilities. Further, in a case where the second information is included in the first information in the invalidated state, it is possible to interpret the invalidated second information and thereby cause the image processing apparatus 105 of a predetermined maker to perform image reading specific to the image processing apparatus 105, i.e. execute the second capabilities. Thus, in the present embodiment, it is possible to acquire the first information and the second information by using one common protocol and cause the image processing apparatus 105 to execute the first capabilities and the second capabilities. Note that although the second information is included in the first information in the present embodiment, this is not limitative, but for example, the second information can exist outside the first information. In a case where the second information exists outside the first information, the information processing apparatus 104 acquires the first information and the second information separately.

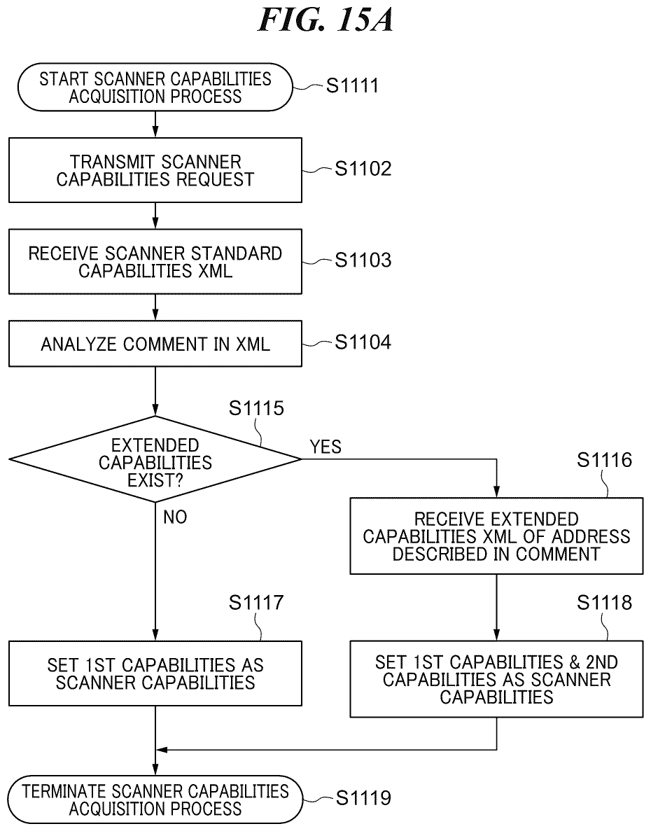

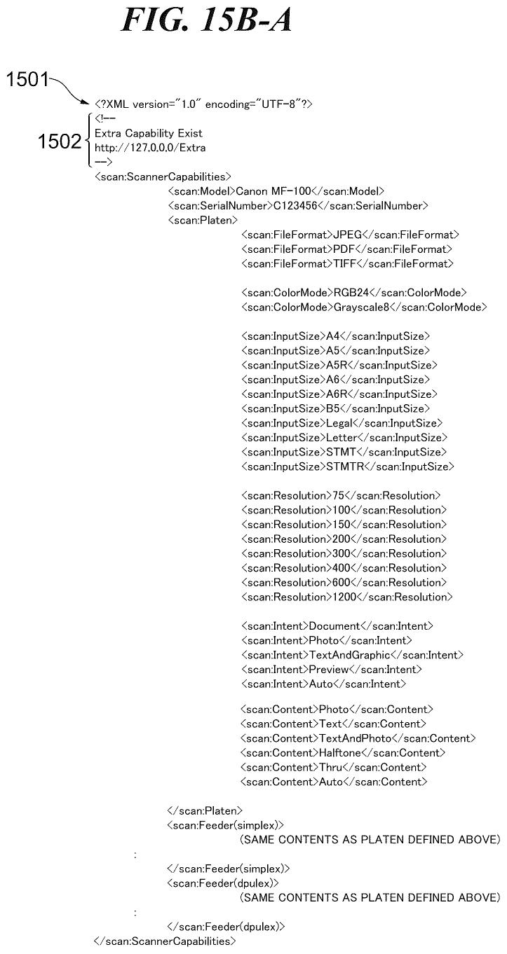

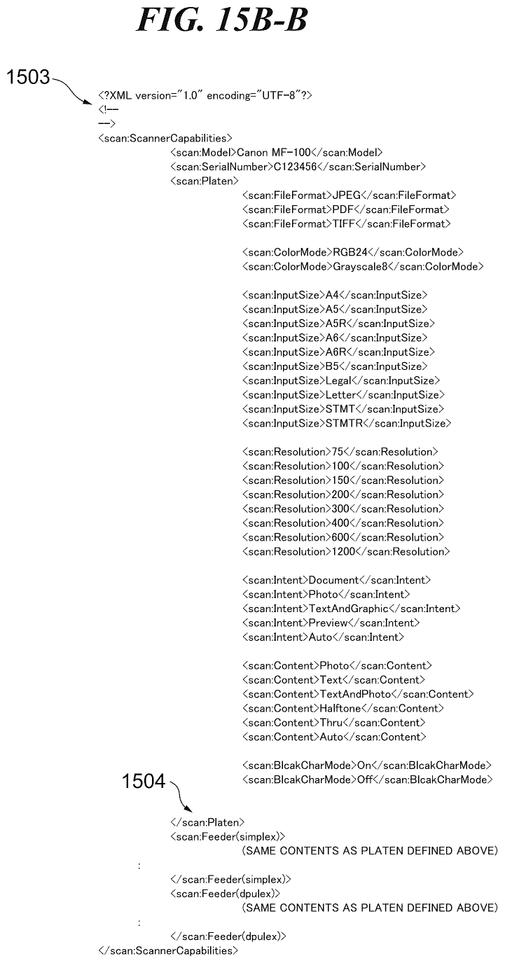

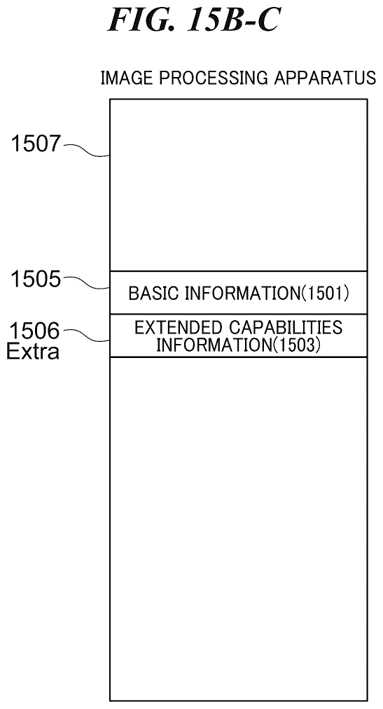

A second embodiment will be described below with reference to FIGS. 15A and 15B, but the description will be given mainly of different points from the above-described embodiment, and description of the same points is omitted. The present embodiment is the same as the first embodiment except that the scanner capabilities acquisition process is different. FIG. 15A is a flowchart showing details (subroutine) of the scanner capabilities acquisition process in the step S1005 in FIG. 10 in the second embodiment. FIGS. 15B-A to 15B-C are diagrams showing information concerning the reading section of the image processing apparatus. FIG. 15B-A is a diagram showing the first capabilities which can be executed by the reading section of the image processing apparatus. FIG. 15B-B is a diagram showing the second capabilities which can be executed by the reading section of the image processing apparatus. FIG. 15B-C is a diagram showing a memory map of the ROM-RAM of the image processing apparatus. As shown in FIG. 15A, in a step S1111, the scanner capabilities acquisition process is started. Then, the step S1102, the step S1103, and the step S1104 are sequentially executed, and after execution of the step S1104, the process proceeds to a step S1115.

In the step S1115, as a result of the analysis in the step S1104, the configuration information acquisition section 425 determines whether or not the second information exists in the first information, i.e. whether or not the second capabilities which can be executed by the image processing apparatus 105 exist. Here, a case where the configuration information acquisition section 425 has received information 1501 shown in FIG. 15B-A, as the capabilities XML, will be described by way of example. The information 1501 includes a comment 1502. The configuration information acquisition section 425 (detection unit) can analyze the information 1501 from its top and detect the keyword “Extra Capabilities Exist” from the comment 1502. If the keyword has been detected, the configuration information acquisition section 425 determines that the second information exists, and the process proceeds to a step S1116. On the other hand, as a result of the analysis on the information 1501 from its top, if the keyword “Extra Capabilities Exist” has not been detected from the comment 1502, the configuration information acquisition section 425 determines that the second information does not exist, and the process proceeds to a step S1117.

In the step S1116, the configuration information acquisition section 425 acquires address information “http://127.0.0.0/Extra” in the comment 1502. The address information is an address of a storage destination storing the second information. In the present embodiment, this address information is included in the information 1501 (first information) as a character string using at least one of characters, a numeral, and a mark. The configuration information acquisition section 425 transmits a second information request to the storage destination of the second information. Upon receipt of the second information request, the image processing apparatus 105 transmits information 1503 (see FIG. 15B-B) including the second information to the information processing apparatus 104. A memory map 1507 shown in FIG. 15B-C is a memory map of the ROM-RAM 307 of the image processing apparatus 105. In the memory map 1507, information concerning the reading section 316 is stored in an area 1505 as the first information (information 1501). Further, in an area 1506, information (information 1503) including the second information is stored. In the information 1503, information 1504 (Black Char Mode) as the second information is included in a state not enclosed by a comment.

In the step 1117, the configuration information acquisition section 425 treats the first capabilities as the capabilities which can be standardly executed by the reading section 316. In this case, the first information concerning the first capabilities is e.g. the information 701 shown in FIG. 7A. After execution of the step S1117, the process proceeds to a step S1119.

In a step S1118, if the information 1503 transmitted from the image processing apparatus 105 has been received, the configuration information acquisition section 425 acquires the second capabilities based on the information 1504 in the information 1503 and treats the second capabilities as the capabilities which can be uniquely executed by the reading section 316. Further, the configuration information acquisition section 425 treats not only the second capabilities, but also the first capabilities, as the capabilities which can be executed by the reading section 316. After execution of the step S1118, the process proceeds to the step S1119.

In the step S1119, the process is terminated. As described above, similar to the first embodiment, in the present embodiment as well, it is also possible to acquire the first information and the second information by using one common protocol and cause the image processing apparatus 105 to execute the first capabilities and the second capabilities. Note that although in the present embodiment, the storage destination of the second information is included in the first information, this is not limitative, but for example, the second information can exist outside the first information. In a case where the second information exists outside the first information, the information processing apparatus 104 acquires the first information and the storage destination of the second information, separately. Further, the information processing apparatus 104 acquires the second information based on the storage destination of the second information.

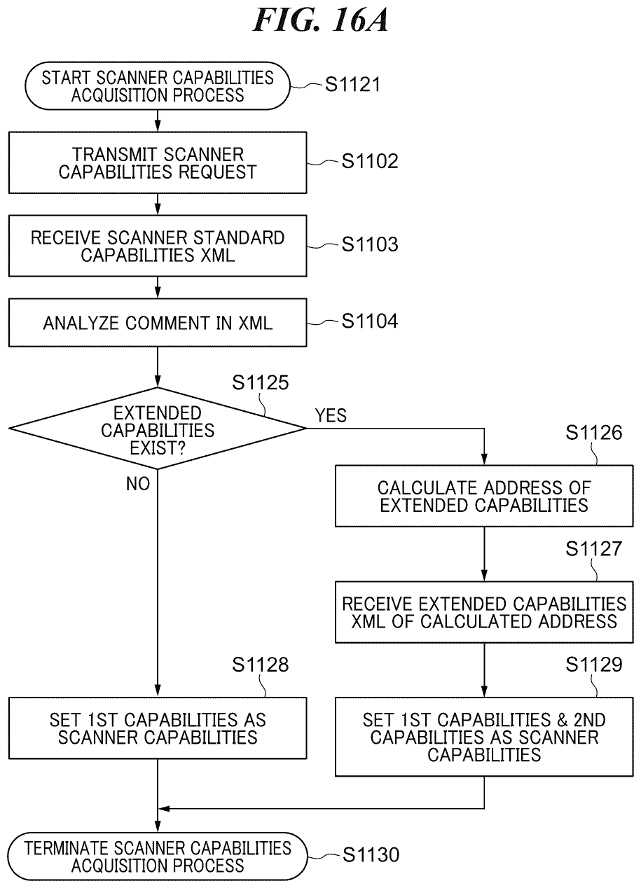

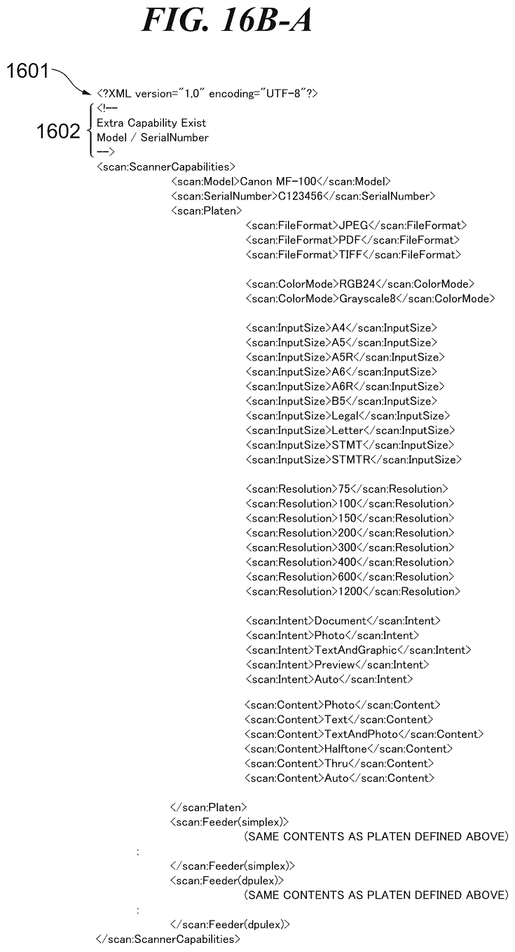

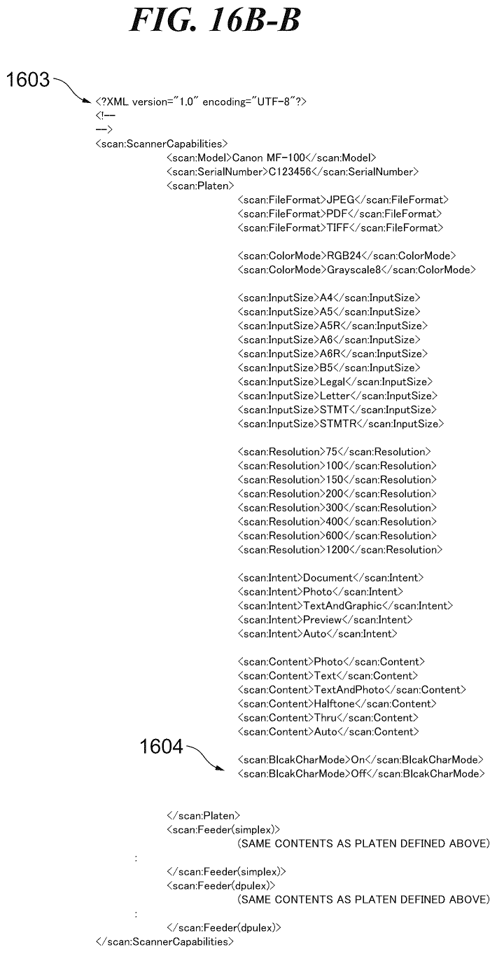

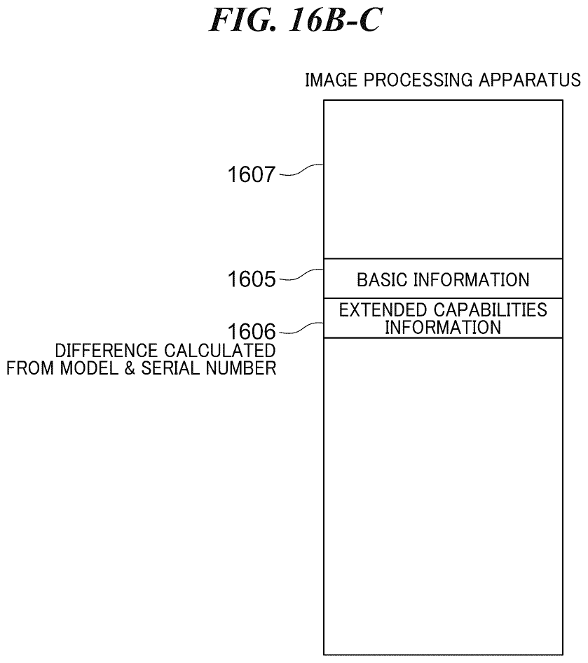

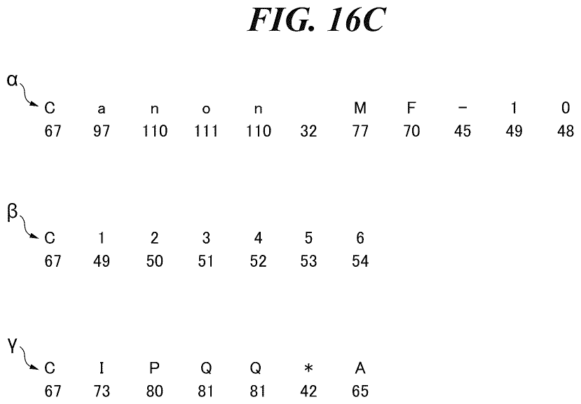

A third embodiment will be described below with reference to FIGS. 16A to 16C, but the description will be given mainly of different points from the above-described embodiments, and description of the same points is omitted. The present embodiment is the same as the second embodiment except that the scanner capabilities acquisition process is different. FIG. 16A is a flowchart showing details (subroutine) of the scanner capabilities acquisition process in the step S1005 in FIG. 10 in the third embodiment. FIGS. 16B-A to 16B-C are diagrams showing information concerning the reading section of the image processing apparatus. FIG. 16B-A is a diagram showing the first capabilities which can be executed by the reading section of the image processing apparatus. FIG. 16B-B is a diagram showing the second capabilities which can be executed by the reading section of the image processing apparatus. FIG. 16B-C is a diagram showing a memory map of the ROM-RAM of the image processing apparatus. FIG. 16C is a diagram useful in explaining an example of calculation of address information.

As shown in FIG. 16A, in a step S1121, the scanner capabilities acquisition process is started. Then, the steps S1102 to S1104 are sequentially executed, and after execution of the step S1104, the process proceeds to a step S1125.

In the step S1125, as a result of the analysis in the step S1104, the configuration information acquisition section 425 determines whether or not the second information exists in the first information, i.e. whether or not the second capabilities which can be executed by the image processing apparatus 105 exist. Here, a case where the configuration information acquisition section 425 has received information 1601 shown in FIG. 16B-A as the capabilities XML will be described by way of example. The information 1601 includes a comment 1602. Then, the configuration information acquisition section 425 analyzes the information 1601 from its top, and if the keyword “Extra Capabilities Exist” has been detected from the comment 1602, the configuration information acquisition section 425 determines that the second information exists, and the process proceeds to a step S1126. On the other hand, as a result of the analysis on the information 1601 from its top, if the keyword “Extra Capabilities Exist” has not been detected from the comment 1602, the configuration information acquisition section 425 determines that the second information does not exist, and the process proceeds to a step S1128.

In the step S1126, the configuration information acquisition section 425 calculates address information from a value “Model/Serial Number” of an item in the comment 1602. The value of the item includes “Model” and “Serial Number” as the values of the acquired first capabilities (standard capabilities). In the present embodiment, the value of “Model” is e.g. “Canon MF-100”. The value of “Serial Number” is e.g. “C123456”. The calculation of the address information will be described with reference to FIG. 16C, but this is not limitative. A value α is the value of Model represented by ASCII codes shown in a row under the respective characters of “Canon MF-100”. A value 3 is the value of Serial Number represented by ASCII codes shown in a row under the respective characters of “C123456”. In the calculation of the address information, the number of columns is set to 7 in accordance with the number of columns of the value β, which is the shorter, and a value is calculated by adding the ASCII codes of the respective columns of the value α and the value β, on a character-by-character basis, and dividing the obtained value by 2. Results of the calculation as ASCII codes are shown in the lower row of a value γ. Characters converted from the ASCII codes in the lower row are indicated as “CIPQQ*A” in the upper row of the value γ. Then, this value γ is set as difference information for the second capabilities (extended capabilities), and the address “/CIPQQ*A” of the image processing apparatus 105 is calculated as the address information for acquiring the second capabilities.

In a step S1127, the configuration information acquisition section 425 transmits a scanner capabilities request to the address “/CIPQQ*A” of the image processing apparatus 105, acquired in the step S1126. Upon receipt of the scanner capabilities request, the image processing apparatus 105 transmits information 1603 shown in FIG. 16B-B to the information processing apparatus 104. The information 1603 includes the information concerning the second capabilities, i.e. the second information. A memory map 1607shown in FIG. 16B-C is a memory map of the ROM-RAM 307 of the image processing apparatus 105. In the memory map 1607, the information concerning the reading section 316 is stored in an area 1605 as the first information (information 1601). Further, in an area 1606, a scanner capabilities set is stored. The scanner capabilities set includes the extended capabilities at a location of the address “/CIPQQ*A” of the image processing apparatus 105. The image processing apparatus 105 transmits the information 1603 stored in the area 1606 as the capabilities XML. The information 1603 includes information 1604 (Black Char Mode) as the second information in a state not enclosed by a comment.

In the step S1128, the configuration information acquisition section 425 treats the first capabilities as the capabilities which can be standardly executed by the reading section 316. In this case, for example, the first information concerning the first capabilities is e.g. the information 701 shown in FIG. 7A. After execution of the step S1128, the process proceeds to a step S1130.

In a step S1129, in a case where the information 1603 transmitted from the image processing apparatus 105 has been received, the configuration information acquisition section 425 acquires the second capabilities based on the information 1604 in the information 1603 and treats the second capabilities as the capabilities which can be uniquely executed by the reading section 316. Further, the configuration information acquisition section 425 treats not only the second capabilities, but also the first capabilities, as the capabilities which can be executed by the reading section 316. After execution of the step S1129, the process proceeds to the step S1130.

In the step S1130, the process is terminated. As described above, similar to the second embodiment, in the present embodiment, it is also possible to acquire the first information and the second information and enable the image processing apparatus 105 to execute the first capabilities and the second capabilities.

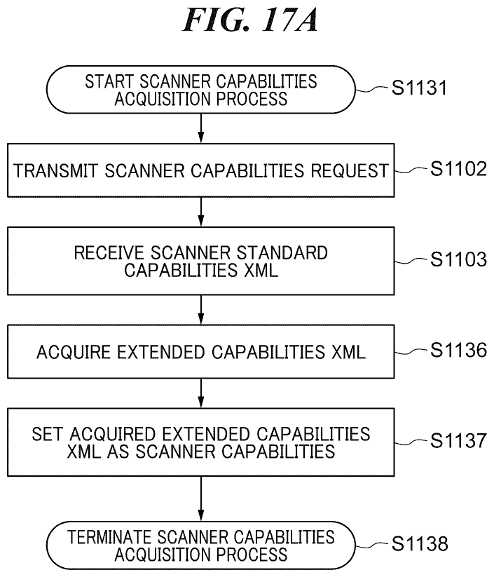

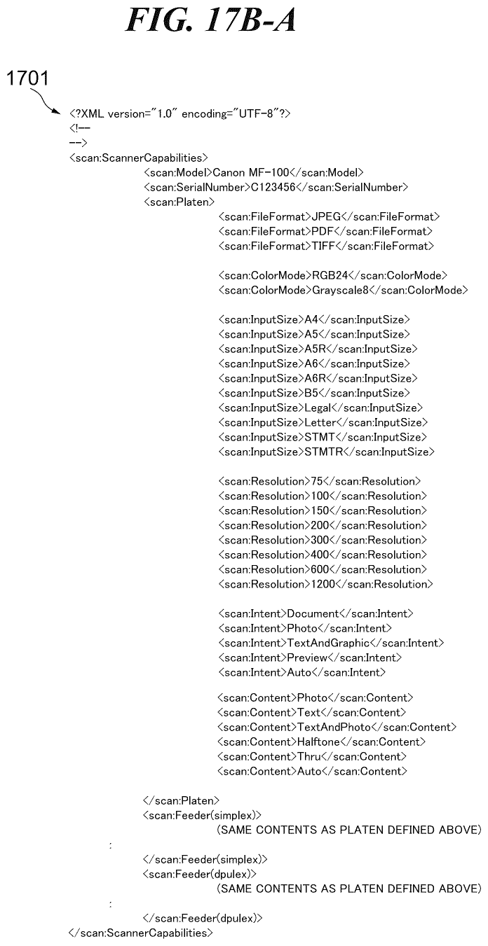

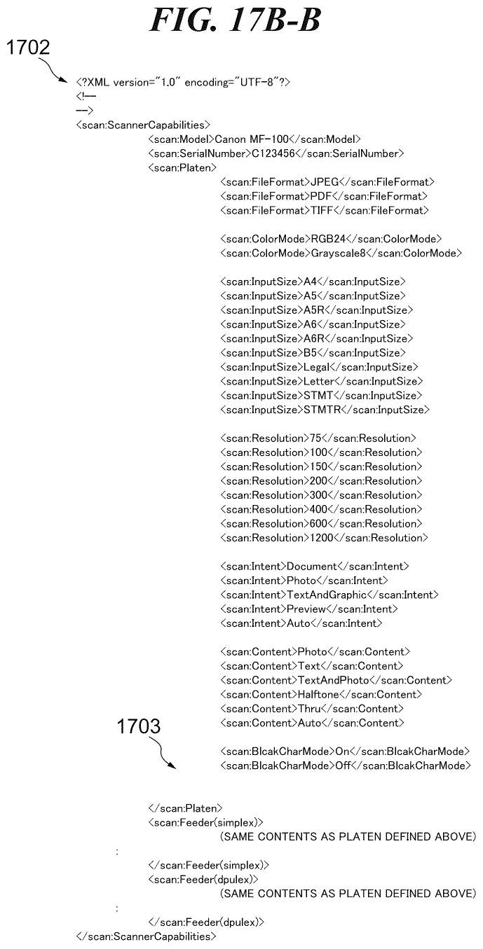

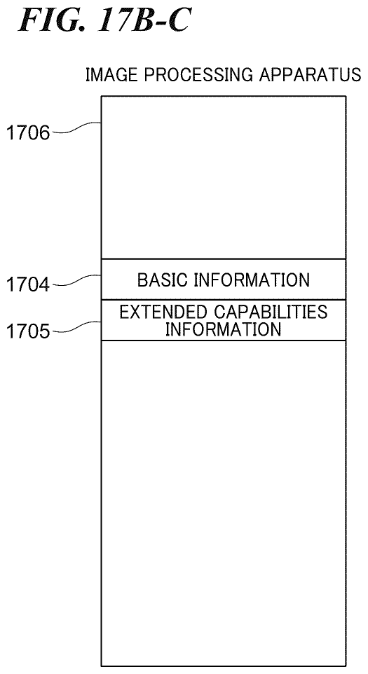

A fourth embodiment will be described below with reference to FIG. 17A and FIGS. 17B-A to 17B-C, but the description will be given mainly of different points from the above-described embodiments, and description of the same points is omitted. The present embodiment is the same as the third embodiment except that the scanner capabilities acquisition process is different. FIG. 17A is a flowchart showing details (subroutine) of the scanner capabilities acquisition process in the step S1005 in FIG. 10 in the fourth embodiment. FIGS. 17B-A to 17B-C are diagrams showing information concerning the reading section of the image processing apparatus. FIG. 17B-A is a diagram showing the first capabilities which can be executed by the reading section of the image processing apparatus. FIG. 17B-B is a diagram showing the second capabilities which can be executed by the reading section of the image processing apparatus. FIG. 17B-C is a diagram showing a memory map of the ROM-RAM of the image processing apparatus.

As shown in FIG. 17A, in a step S1131, the scanner capabilities acquisition process is started. Then, the steps S1102 and S1103 are sequentially executed, and after execution of the step S1103, the process proceeds to a step S1136.

A memory map 1706 shown in FIG. 17B-C is a memory map of the ROM-RAM 307 of the image processing apparatus 105. In the memory map 1706, the information concerning the reading section 316 is stored in an area 1704 as the first information (information 1701 shown in FIG. 17B-B). Further, in a case where a scanner capabilities request has been received to the IP address of the image processing apparatus 105, the image processing apparatus 105 transmits the information 1701 stored at the location of the area 1704 as the capabilities XML. In an area 1705, a scanner capabilities set is held. In the scanner capabilities set, the extended capabilities is included at a location of the address “/Extra” of the image processing apparatus 105. The image processing apparatus 105 transmits information 1702 (see FIG. 17B-B) stored in the area 1705 as the capabilities XML.

In the step S1136, the configuration information acquisition section 425 transmits a scanner capabilities request to the address “/Extra” of the scanner capabilities set including the second capabilities. In a case where the scanner capabilities request has been received, the image processing apparatus 105 transmits the information 1702 shown in FIG. 17B-B to the information processing apparatus 104 as a response. The information 1702 includes information 1703 (Black Char Mode) as the second information in a state not enclosed by a comment.

In a step S1137, in a case where the information 1702 transmitted from the image processing apparatus 105 has been received, the configuration information acquisition section 425 acquires the second capabilities based on the information 1703 in the information 1702 and treats the second capabilities as the capabilities which can be uniquely executed by the reading section 316. Note that in a case where the information 1702 has not been received, or acquisition of the information 1702 has failed, the configuration information acquisition section 425 directly treats the information 1701 as the first information. After execution of the step S1137, the process proceeds to a step S1138.

In the step S1138, the process is terminated. As described above, similar to the third embodiment, in the present embodiment, it is also possible to acquire the first information and the second information and enable the image processing apparatus 105 to execute the first capabilities and the second capabilities.

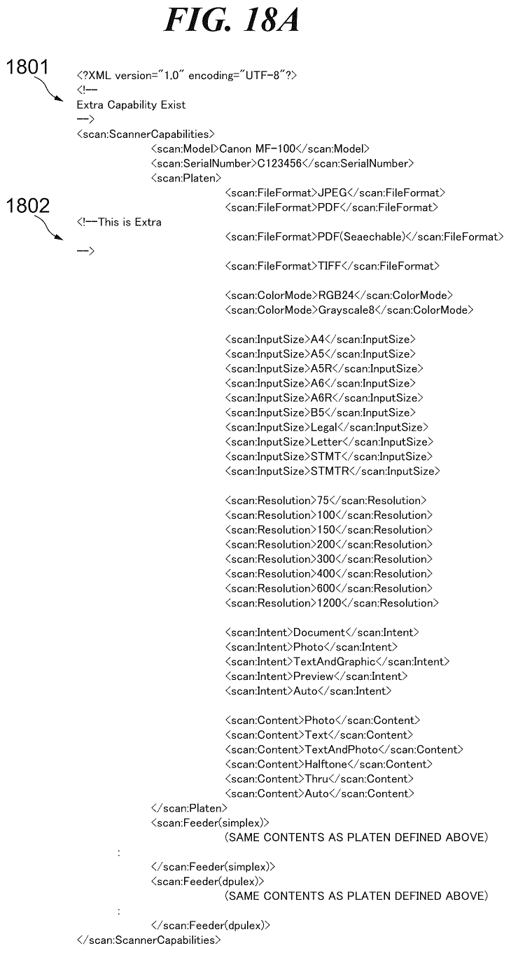

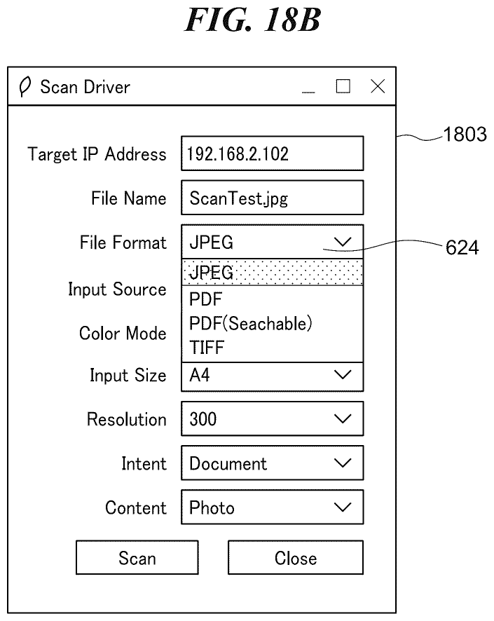

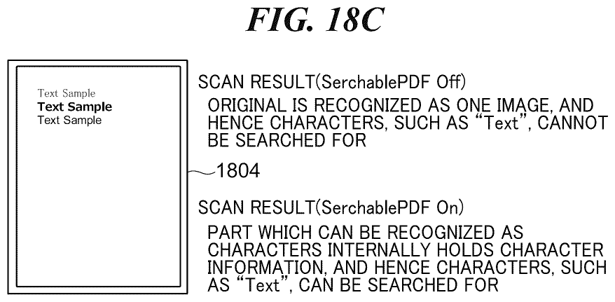

A fifth embodiment will be described below with reference to FIGS. 18A to 18C, but the description will be given mainly of different points from the above-described embodiments, and description of the same points is omitted. The present embodiment is the same as the first embodiment except that a second capability is different. Note that in the first embodiment, “Black Char Mode” is described as an example of the second capability. In the present embodiment, “Searchable PDF” will be described as an example of the second capability.

FIGS. 18A to 18C are diagrams concerning the reading section of the image processing apparatus according to the fifth embodiment. FIG. 18A is a diagram showing the second capabilities which can be executed by the reading section of the image processing apparatus. FIG. 18B shows a scanner driver screen. FIG. 18C is a diagram showing an example of an original. In a case where the image processing apparatus 105 supports a function of generating Searchable PDF, the image processing apparatus 105 transmits information 1801 shown in FIG. 18A to the information processing apparatus 104 as the second capabilities (extended capabilities). The information 1801 includes a comment 1802. In the comment 1802, the capability of Searchable PDF is defined. Further, a scanner driver screen 1803 shown in FIG. 18B is displayed. The operation area 624 of the scanner driver screen 1803 further includes, as the options, not only “JPEG”, “PDF”, and “TIFF”, but also an option 624a “PDF (Searchable)”.

As shown in FIG. 18C, on an original 1804, a character string “Text Sample” is drawn in three types of fonts. In a case where the Searchable PDF is set to the OFF state, i.e. the normal PDF is set, the original 1804 is recognized as one image. Therefore, even where the character string “Text Sample” is included in this image, for example, “Text” cannot be searched for. On the other hand, in a case where the Searchable PDF is set to the ON state, “Text” can be searched for by the application software 415.

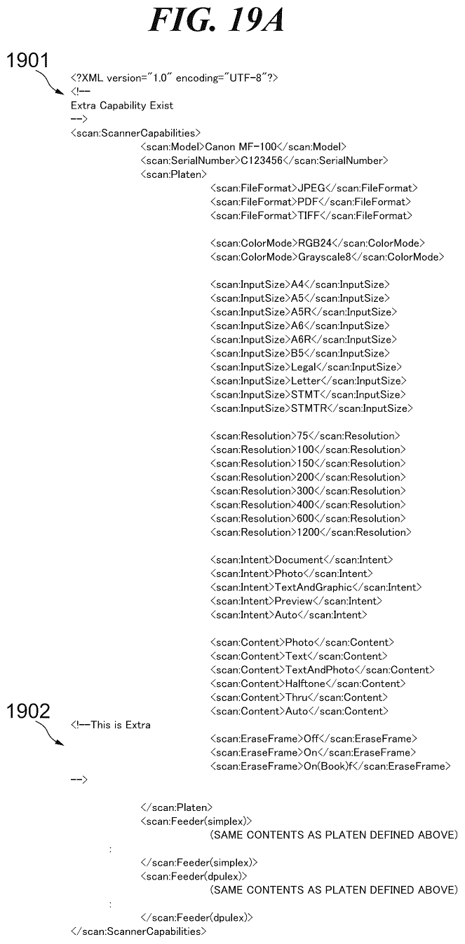

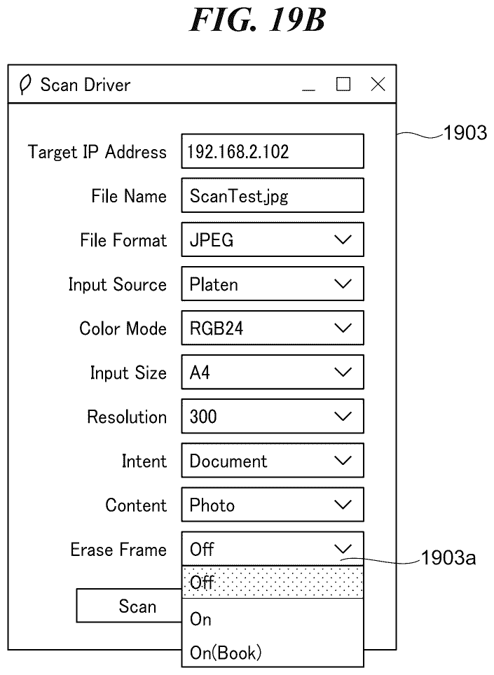

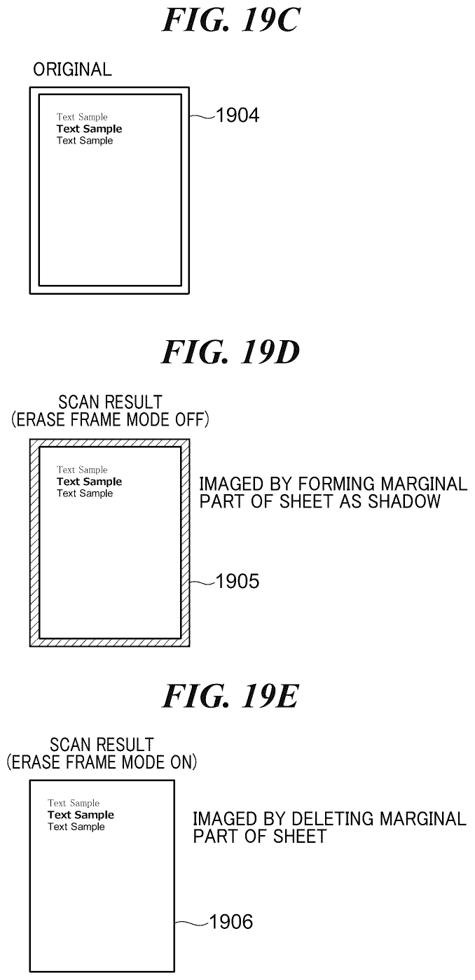

A sixth embodiment will be described below with reference to FIGS. 19A to 19E, but the description will be given mainly of different points from the above-described embodiments, and description of the same points is omitted. The present embodiment is the same as the fifth embodiment except that a second capability is different. In the present embodiment, “Erase Frame” will be described as an example of the second capability.

FIGS. 19A to 19E are diagrams concerning the reading section of the image processing apparatus according to the sixth embodiment. FIG. 19A is a diagram showing the second capabilities which can be executed by the reading section of the image processing apparatus. FIG. 19B shows a scanner driver screen. FIG. 19C is a diagram showing an example of an original. FIGS. 19D and 19E are diagrams each showing a read image of the original shown in FIG. 19C. In a case where the image processing apparatus 105 supports the Erase Frame function, the image processing apparatus 105 transmits information 1901 shown in FIG. 19A to the information processing apparatus 104 as the second capabilities (extended capabilities). The information 1901 includes a comment 1902. In the comment 1902, the capability of Erase Frame is defined. Further, a scanner driver screen 1903 shown in FIG. 19B is displayed. An operation area 1903a of the scanner driver screen 1903 includes “Off”, “On”, and “On (Book)”, as the options of Erase Frame.

As shown in FIG. 19C, on an original 1904, the character string “Text Sample” is drawn in three types of fonts. In a case where the original 1904 is read by the reading section 514, for example, an image 1905 shown in FIG. 19D can be obtained. On the image 1905, edge part of the original 1904 becomes a shadow and is acquired as lines. To overcome this inconvenience, the Erase Frame function is used, whereby an image 1906 shown in FIG. 19E is obtained. On the image 1906, the lines acquired as the shadow on the edge part of the original 1904 are erased. Note that for example, in a case where a book in an opened state is read by the reading section 514, the central part of the book, which is floated from the original platen glass, becomes a shadow, and can be acquired as lines. In this case, by selecting “On (Book)” in the operation area 1903a, it is possible to erase the lines on the central part of the book.

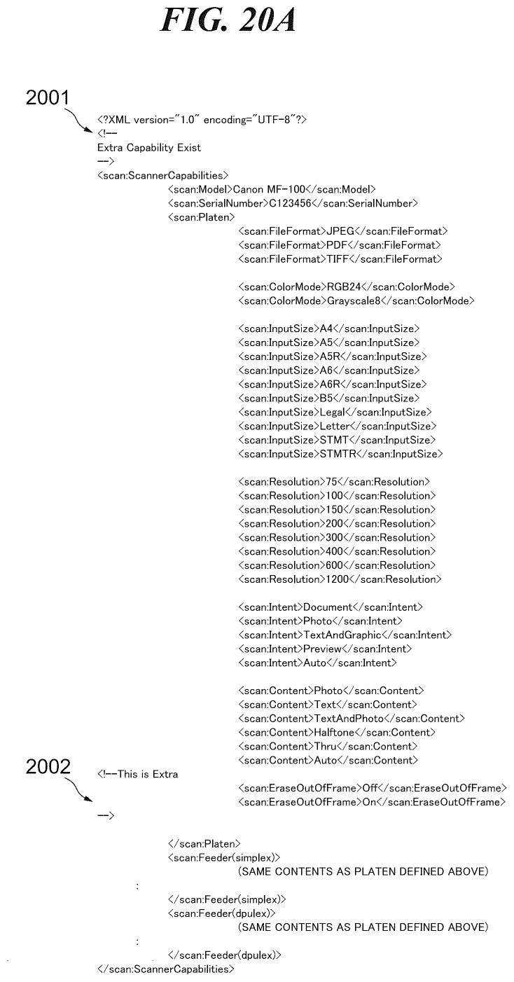

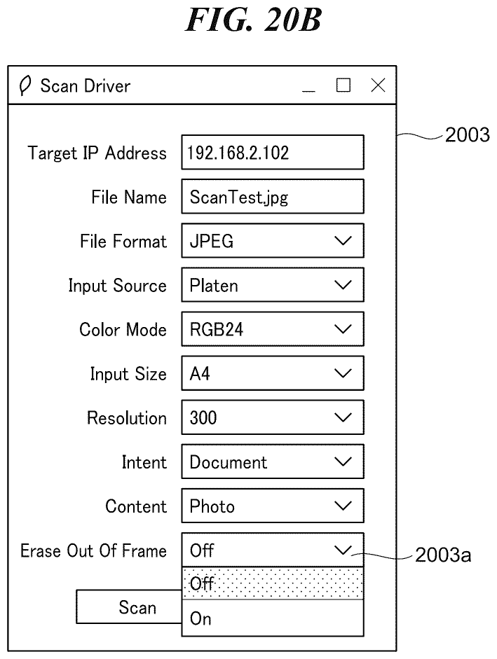

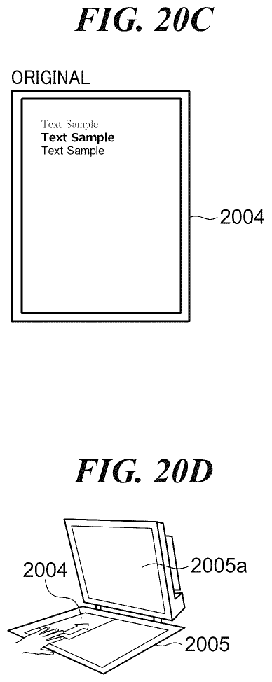

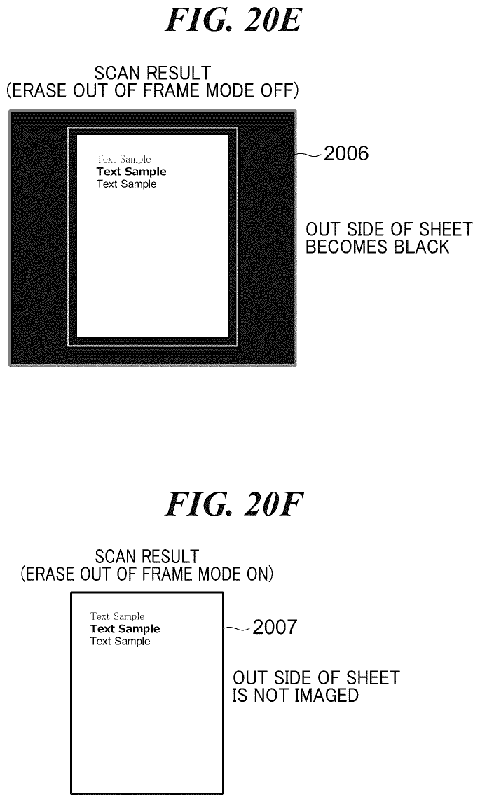

A seventh embodiment will be described below with reference to FIGS. 20A to 20F, but the description will be given mainly of different points from the above-described embodiments, and description of the same points is omitted. The present embodiment is the same as the fifth embodiment except that a second capability is different. In the present embodiment, “Erase Out Of Frame” will be described as an example of the second capabilities.

FIGS. 20A to 20F are diagrams concerning the reading section of the image processing apparatus according to the seventh embodiment. FIG. 20A is a diagram showing the second capabilities which can be executed by the reading section of the image processing apparatus. FIG. 20B shows a scanner driver screen. FIG. 20C is a diagram showing an example of an original. FIG. 20D is a diagram showing a state in which the original shown in FIG. 20C is placed on the original platen glass. FIGS. 20E and 20F are diagrams each showing a read image of the original shown in FIG. 20C. In a case where the image processing apparatus 105 supports the Erase Out Of Frame function, the image processing apparatus 105 transmits information 2001 shown in FIG. 20A to the information processing apparatus 104 as the second capabilities (extended capabilities). The information 2001 includes a comment 2002. In the comment 2002, the capability of Erase Out Of Frame is defined. Further, a scanner driver screen 2003 shown in FIG. 20B is displayed. An operation area 2003a of the scanner driver screen 2003 includes, as the options of the Erase Out Of Frame, “Off” and “On”.

As shown in FIG. 20C, on an original 2004, a character string “Text Sample” is drawn in three types of fonts. As shown in FIG. 20D, the original 2004 is read in a state placed on an original platen glass 2005. For example, in a case where the plurality of original sheets 2004 are placed on the original platen glass in a stacked state, there is a fear that a cover 2005a cannot be fully closed. In this case, for example, an image 2006 shown in FIG. 20E can be obtained. In the image 2006, the outside of the original 2004 all becomes black. Then, in a case where “On” in the operation area 2003a on the scanner driver screen 2003 is selected and the original 2004 is read without closing the cover 2005a, for example, an image 2007 shown in FIG. 20F is obtained. On the image 2007, the outside of the original 2004 all becomes white, and a favorable image is obtained.

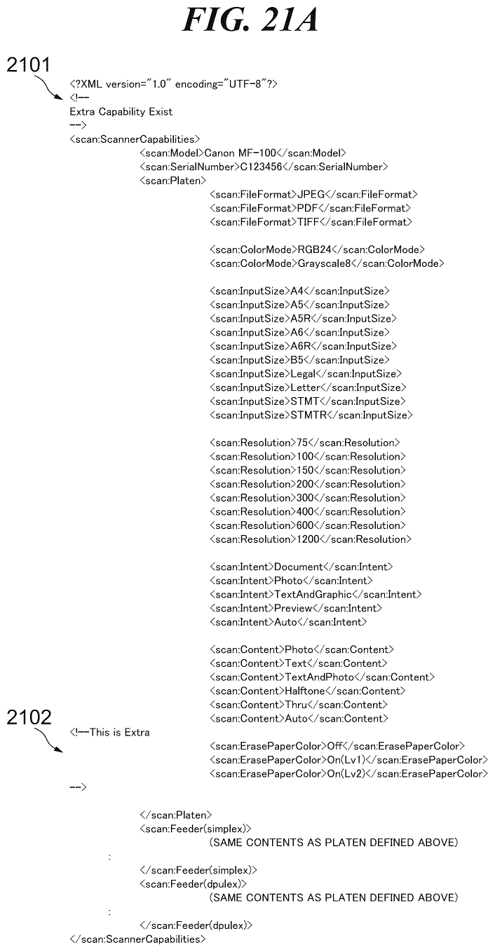

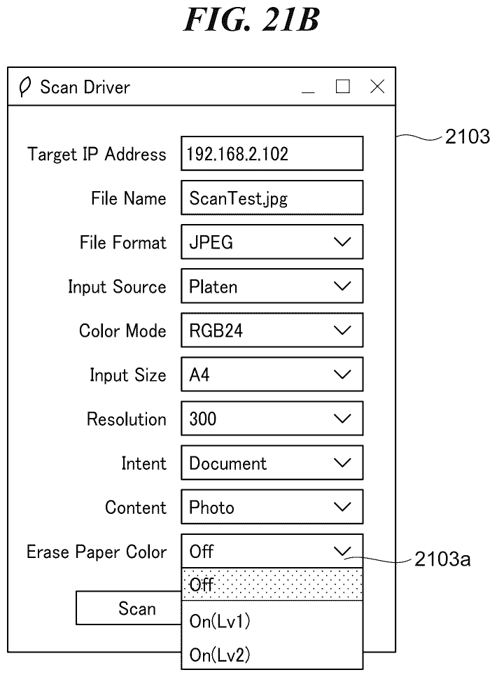

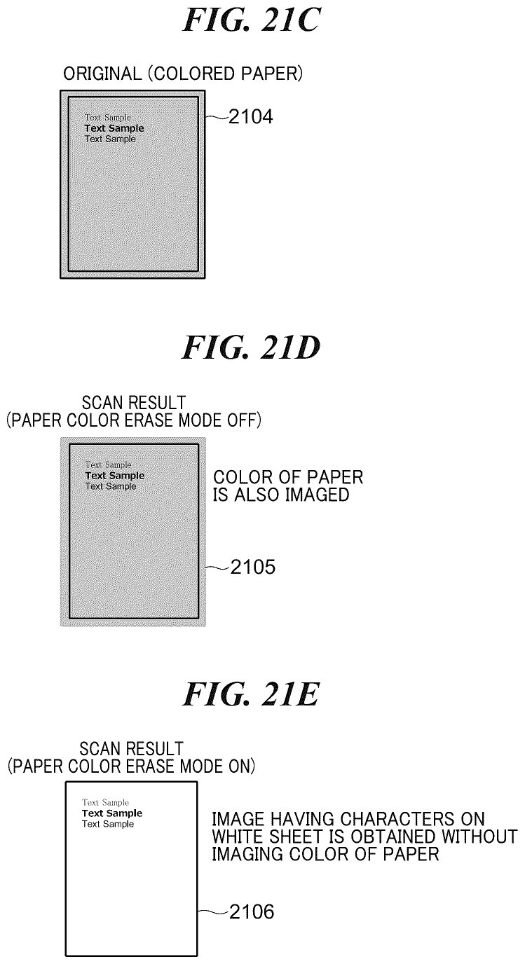

An eighth embodiment will be described below with reference to FIGS. 21A to 21E, but the description will be given mainly of different points from the above-described embodiments, and description of the same points is omitted. The present embodiment is the same as the fifth embodiment except that a second capability is different. In the present embodiment, “Erase Paper Color” will be described as an example of the second capability.

FIGS. 21A to 21E are diagrams concerning the reading section of the image processing apparatus according to the eighth embodiment. FIG. 21A is a diagram showing the second capabilities which can be executed by the reading section of the image processing apparatus. FIG. 21B shows a scanner driver screen. FIG. 21C is a diagram showing an example of an original. FIGS. 21D and 21E are diagrams each showing a read image of the original shown in FIG. 21C. In a case where the image processing apparatus 105 supports the Erase Paper Color function, the image processing apparatus 105 transmits information 2101 shown in FIG. 21A to the information processing apparatus 104 as the second capabilities (extended capabilities). The information 2101 includes a comment 2102. In the comment 2102, the capability of Erase Paper Color is defined. Further, a scanner driver screen 2103 shown in FIG. 21B is displayed. An operation area 2103a of the scanner driver screen 2103 includes “Off”, “On (Lv1)”, and “On (Lv2)”, as the options of the Erase Paper Color.

As shown in FIG. 21C, on an original 2104, a character string “Text Sample” is drawn in three types of fonts. Further, the original 2104 is a colored paper on which a color is applied. In a case where “Off” is selected from the options in the operation area 2103a, and the original 2104 is read by the reading section 514, for example, an image 2105 shown in FIG. 21D can be obtained. On the image 2105, the color of the original 2104 is also reflected. On the other hand, in a case where “On (Lv1)” or “On (Lv2)” is selected from the options in the operation area 2103a, and the original 2104 is read by the reading section 514, for example, an image 2106 shown in FIG. 21E is obtained. On the image 2106, the color of the original 2104 is not reflected. Note that the level of the degree of eliminating the color of the original can be changed between a case where the “On (Lv1)” is selected and a case where the “On (Lv2)” is selected.

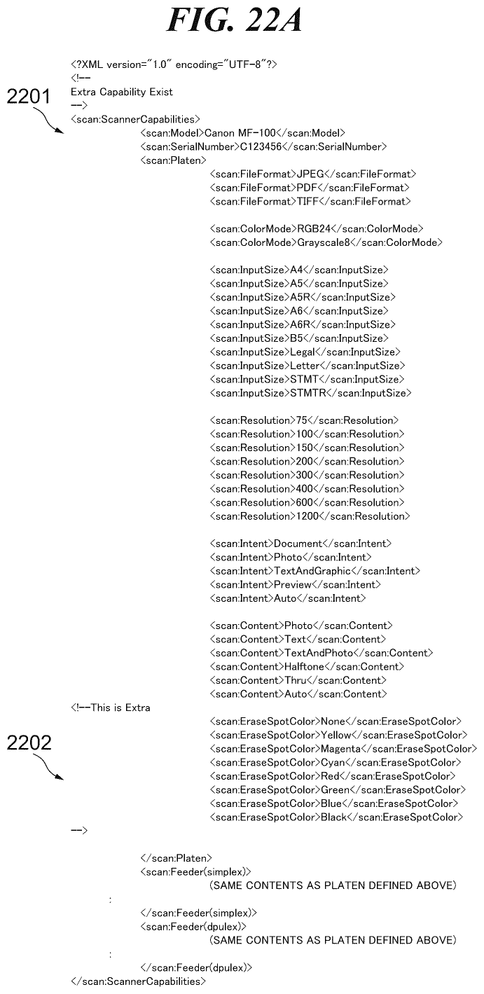

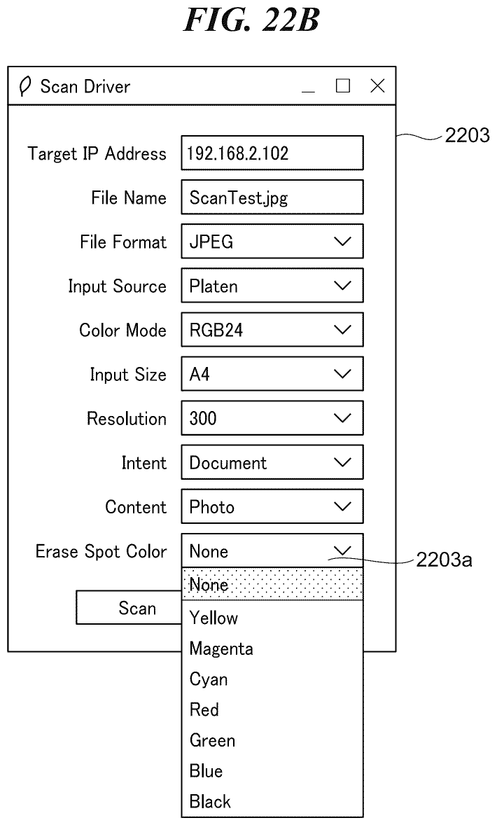

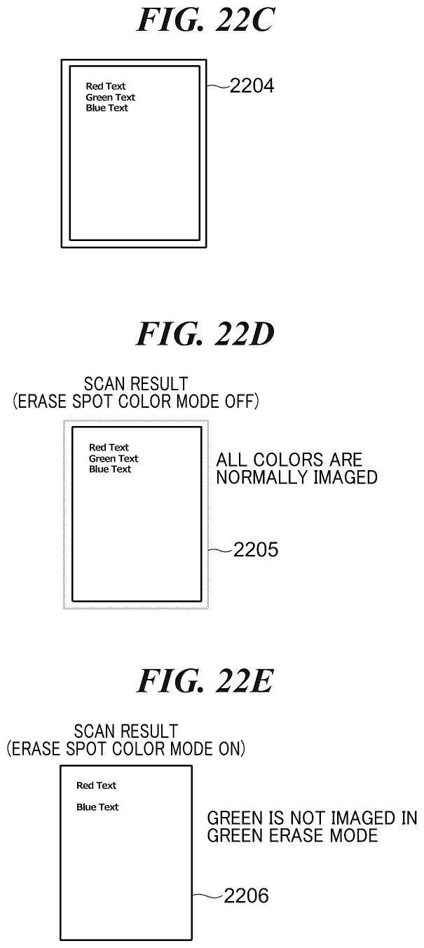

A ninth embodiment will be described below with reference to FIGS. 22A to 22E, but the description will be given mainly of different points from the above-described embodiments, and description of the same points is omitted. The present embodiment is the same as the fifth embodiment except that a second capability is different. In the present embodiment, “Erase Spot Color” will be described as an example of the second capability.

FIGS. 22A to 22E are diagrams concerning the reading section of the image processing apparatus according to the ninth embodiment. FIG. 22A is a diagram showing the second capabilities which can be executed by the reading section of the image processing apparatus. FIG. 22B shows a scanner driver screen. FIG. 22C is a diagram showing an example of an original. FIGS. 22D and 22E are diagrams each showing a read image of the original shown in FIG. 22C. In a case where the image processing apparatus 105 supports the Erase Spot Color function, the image processing apparatus 105 transmits information 2201 shown in FIG. 22A to the information processing apparatus 104 as the second capabilities (extended capabilities). The information 2201 includes a comment 2202. In the comment 2202, the capability of Erase Spot Color is defined. Further, a scanner driver screen 2203 shown in FIG. 22B is displayed. An operation area 2203a of the scanner driver screen 2203 includes “None”, “Yellow”, “Magenta”, “Cyan”, “Red”, “Green”, “Blue”, and “Black”, as the options of the Erase Spot Color.

As shown in FIG. 22C, on an original 2204, character strings “Red Text”, “Green Text”, and “Blue Text” are drawn. The character string “Red Text” is printed in red. The character string “Green Text” is printed in green. The character string “Blue Text” is printed in blue. In a case where “None” is selected form the options in the operation area 2203a, and the original 2204 is read by the reading section 514, for example, an image 2205 shown in FIG. 22D can be obtained. On the image 2205, the character strings “Red Text”, “Green Text”, and “Blue Text” are included. On the other hand, in a case where “Green” is selected from the options in the operation area 2203a, and the original 2204 is read by the reading section 514, for example, an image 2206 shown in FIG. 22E is obtained. On the image 2206, the character strings “Red Text” and “Blue Text” are included, but the character string “Green Text” is not included. Thus, by appropriately selecting an option in the operation area 2203a, it is possible to omit reading of a character string of a predetermined color.

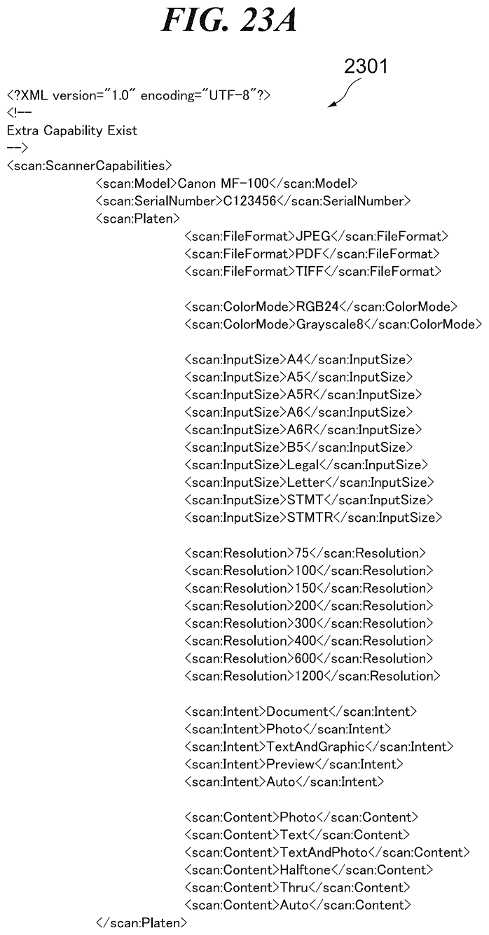

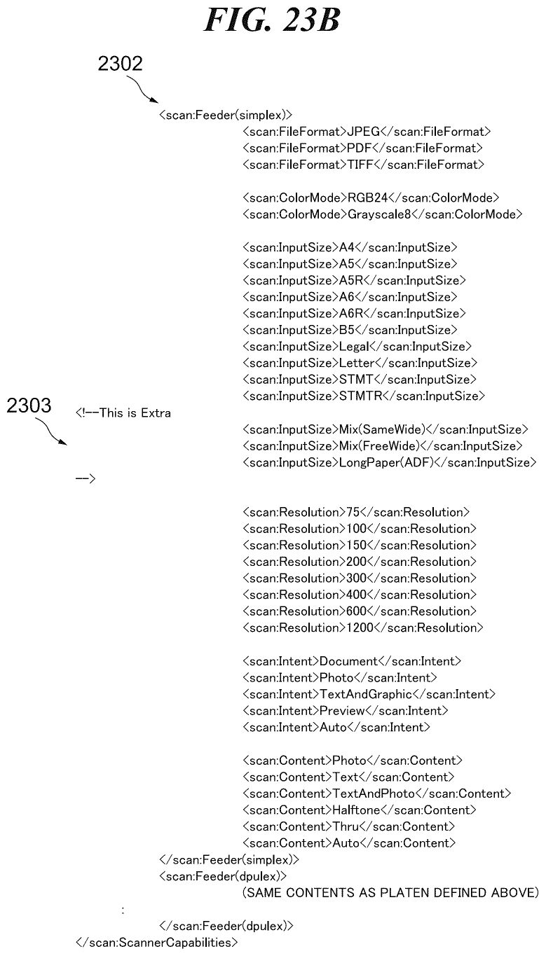

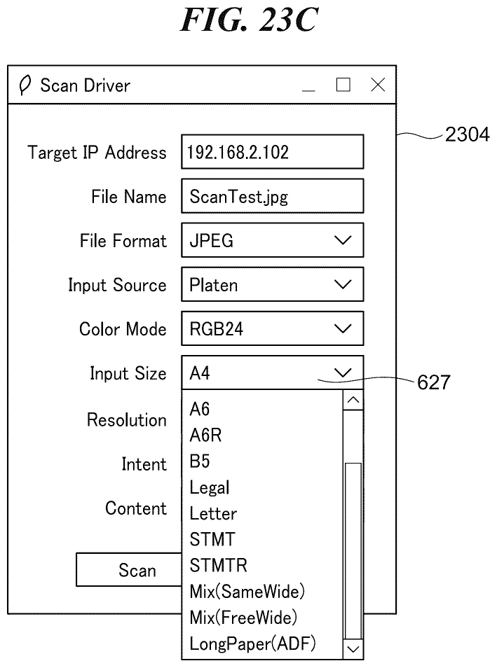

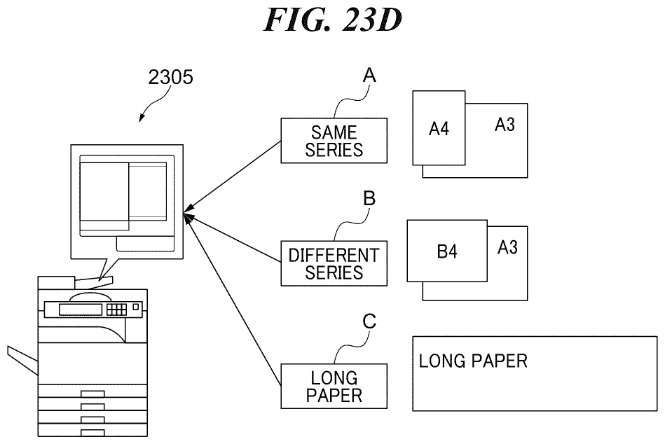

A tenth embodiment will be described below with reference to FIGS. 23A to 23D, but the description will be given mainly of different points from the above-described embodiments, and description of the same points is omitted. The present embodiment is the same as the fifth embodiment except that a second capability is different. In the present embodiment, “Input Size” will be described as an example of the second capability.

FIGS. 23A to 23D are diagrams concerning the reading section of the image processing apparatus according to the tenth embodiment. FIGS. 23A and 23B are diagrams showing the capabilities which can be executed by the reading section of the image processing apparatus. FIG. 23C shows a scanner driver screen 2304. FIG. 23D is a diagram showing patterns when respective options are selected on a scanner driver screen 2305. In a case where the image processing apparatus 105 supports a function of setting a special sheet size to the ADF, the image processing apparatus 105 transmits information 2301 shown in FIG. 23A and information 2302 shown in FIG. 23B to the information processing apparatus 104. The information 2301 is the capabilities information applied when the option of Input Source indicates Platen, i.e. when the original platen glass is used. The information 2302 is the capabilities information applied when the option of Input Source indicates the processing of reading only one side of the original from the ADF. The information 2302 includes a comment 2303. In the comment 2303, the capability of Input Size, concerning the special sheet size set to the ADF, is defined. Further, a scanner driver screen 2304 shown in FIG. 23C is displayed. The operation area 627 of the scanner driver screen 2304 further includes “Mix (Same Wide)”, “Mix (Free Wide)”, and “Long Paper (ADF)”, as the options. By selecting “Mix (Same Wide)”, it is possible to set a pattern A appearing in FIG. 23D, in which the sizes of sheets placed on the ADF are set to the sizes of sheets of the same series, with the same width. By selecting “Mix (Free Wide)”, it is possible to set a pattern B appearing in FIG. 23D, in which the sizes of sheets placed on the ADF are set to the sizes of sheets of different series, with the different widths”. By selecting “Long Paper (ADF)”, it is possible to set a pattern C appearing in FIG. 23D, in which a long-size sheet, such as a sheet used for Japanese New Year calligraphy, is used for the ADF”.

The present invention has been described heretofore based on the embodiments thereof. However, the present invention is not limited to the above-described embodiments, but it can be practiced in various forms, without departing from the spirit and scope thereof. The present invention can also be accomplished by supplying a system or an apparatus with a program realizing one or more functions of the above-described embodiments via a network or a storage medium, and execution of the program by one or more processors of a computer of the system or apparatus. Further, the present invention can also be realized by a circuit (such as an ASIC) that realizes one or more functions. For example, as the program, a general-purpose program and an extension program can be included. The general-purpose program is a program which can be commonly used by the reading sections 316 of the image processing apparatuses 105 of the plurality of makers. The extension program is a program which can extend the function of the general-purpose program. Note that the extension program can be a program installed as required. In a case where the general-purpose program and the extension program are included as the program, the general-purpose program can acquire the first information from the image processing apparatus 105, and the extension program can acquire the second information from the image processing apparatus 105. Then, in a case where the first information is acquired by the general-purpose program, and the second information is acquired by the extension program, it is possible to perform the capabilities utilization processing for enabling the reading section 316 to use the first capabilities and the second capabilities. Note that the second information can be included in the first information or can exist outside the first information.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-149235 filed Sep. 14, 2023, which is hereby incorporated by reference herein in its entirety.

What is claimed is:

1. An information processing apparatus that is communicably connected to an image forming apparatus including a reading unit configured to read an image and processes information transmitted and received to and from the image forming apparatus,
wherein the image forming apparatus stores, in advance, first information concerning first capabilities which are commonly set by a plurality of makers of the image forming apparatus and can be standardly executed by the reading unit, and second information concerning second capabilities which are uniquely set by a predetermined maker of the image forming apparatus and can be executed by the reading unit,
the information processing apparatus comprising:
an acquisition unit configured to be capable of acquiring the first information and the second information from the image forming apparatus by using a common protocol commonly set by the plurality of makers of the image forming apparatus; and
a processing unit configured to perform capabilities utilization processing for enabling the reading unit to use the first capabilities with which the first information acquired by the acquisition unit is concerned and the second capabilities with which the second information acquired by the acquisition unit is concerned.

2. A method of controlling an information processing apparatus that is communicably connected to an image forming apparatus including a reading unit configured to read an image and processes information transmitted and received to and from the image forming apparatus,
wherein the image forming apparatus stores, in advance, first information concerning first capabilities which are commonly set by a plurality of makers of the image forming apparatus and can be standardly executed by the reading unit, and second information concerning second capabilities which are uniquely set by a predetermined maker of the image forming apparatus and can be executed by the reading unit,
the method comprising:
acquiring the first information and the second information from the image forming apparatus by using a common protocol commonly set by the plurality of makers of the image forming apparatus; and
performing capabilities utilization processing for enabling the reading unit to use the first capabilities with which the first information acquired by said acquiring is concerned and the second capabilities with which the second information acquired by said acquiring is concerned.

3. A non-transitory computer-readable storage medium storing a program for causing a computer to execute a method of controlling an information processing apparatus that is communicably connected to an image forming apparatus including a reading unit configured to read an image and processes information transmitted and received to and from the image forming apparatus,
wherein the image forming apparatus stores, in advance, first information concerning first capabilities which are commonly set by a plurality of makers of the image forming apparatus and can be standardly executed by the reading unit, and second information concerning second capabilities which are uniquely set by a predetermined maker of the image forming apparatus and can be executed by the reading unit,
the method comprising:
acquiring the first information and the second information from the image forming apparatus by using a common protocol commonly set by the plurality of makers of the image forming apparatus; and
performing capabilities utilization processing for enabling the reading unit to use the first capabilities with which the first information acquired by said acquiring is concerned and the second capabilities with which the second information acquired by said acquiring is concerned.

4. The storage medium according to claim 3, wherein the second information is included in the first information, in an invalidated state, and
wherein the method further comprises:
determining whether or not the second information exists in the first information acquired by said acquiring; and
said performing includes performing the capabilities utilization processing in a case where it is determined by said determining that the second information exists.

5. The storage medium according to claim 3, wherein in the first information, the second information is in a state invalidated by using a markup language, and
wherein said determining includes determining whether or not the second information exists, based on the markup language.

6. The storage medium according to claim 3, wherein the markup language is XML.

7. The storage medium according to claim 3, wherein the common protocol is eSCL protocol.
